(19) United States
(12) Patent Application Publication
(10) Pub. No.: US 2026/0008706 A1
(43) Pub. Date: Jan. 8, 2026

(54) Utilization of Micro Hydroflocs for the Effective and Complete Removal of Long and Short Chain PFAS Molecules from Contaminated Water

(71) Applicant: StreamGo Water USA LLC, Odessa, FL (US)

(72) Inventor: Marco Polverari, Saint-Leonard (CA)

(73) Assignee: StreamGo Water USA LLC, Odessa, FL (US)

(21) Appl. No.: 19/261,098

(22) Filed: Jul. 7, 2025

Related U.S. Application Data
(60) Provisional application No. 63/668,443, filed on Jul. 8, 2024.

(51) Int. Cl. C02F 9/00; C02F 1/24; C02F 1/32; C02F 1/469; C02F 1/52; C02F 1/56; C02F 1/72; C02F 11/122; C02F 101/36

(52) U.S. Cl. CPC C02F 9/00; C02F 1/24; C02F 1/32; C02F 1/469; C02F 1/5236; C02F 1/56; C02F 1/725; C02F 11/122; C02F 2101/36; C02F 2305/10

(57) ABSTRACT

Various embodiments provide methods for removing concentrations of PFAS from a contaminated stream of water or leachate. In a primary pretreatment stage, the incoming contaminated water is mixed with a hydrophobically associative gelling aid to generate an electroactive microgel with PFAS. In a secondary electrochemical oxidation stage, the electro-active microgel is reacted to reduce the PFAS carbon chain length. In a tertiary electrochemical coagulation stage, microhydrogels are generated which adsorb the degraded PFAS molecules and form microflocs. Lastly nanoparticles are added to the micro hydroflocs to aggregate the micro hydroflocs into macroflocs for easy flotation and removal.

### I. REFERENCE TO RELATED APPLICATIONS

This application claims priority to U.S. Provisional Application No. 63/668,443, entitled Utilization of Micro Hydroflocs for the Effective and Complete Removal of Long and Short Chain PFAS Molecules from Contaminated Water, filed on Jul. 8, 2024, which application is incorporated by reference in its entirety.

### II. TECHNICAL FIELD

This disclosure relates to a method and system for the decontamination of all water media, such as potable, aquifer, brackish water, leachate water or groundwater containing per-and polyfluoroalkyl substances (PFAS) and related compounds such as PFAS precursors, collectively referred to as PFAS contaminants. More specifically, the disclosure relates to a method for concentrating and removing PFAS contaminants from water media, using gelling aids to render the PFAS molecules electroactive, followed by an oxidation process to reduce the carbon chain length of the PFAS molecules and a coagulation process to form micro-hydroflocs. The PFAS molecules are adsorbed into the hydroflocs, which are aerated to separate the flocs from the treated water.

### III. BACKGROUND

PFAS were used largely for their oil and water repellent properties. Applications included consumer products (e.g., upholstery, stain resistant apparel, paper, packaging, raincoats, food packaging, non-stick cookware, carpets, and the electronics industry) and aqueous film-forming foam (AFFF) to fight petroleum-based fires. The chemical properties of PFAS that lead to their use also make their removal and destruction from water difficult with conventional water treatment processes.

Because of their wide use, PFAS effect everyone. PFAS are found in the blood of virtually all humans and animals throughout the world, including newborn babies. Approximately 95% of people tested have PFAS in their blood, and PFAS can be detected in human breast milk and umbilical cord blood. Exposure to PFAS over certain levels may result in adverse health effects, including developmental effects, and independent epidemiological studies link numerous adverse health conditions to high exposures of PFOS (perfluorosulfonic acids) or perfluorooctanoic acids (PFOA), including kidney cancer, testicular cancer, ulcerative colitis, thyroid disease, pregnancy-induced hypertension, high cholesterol, liver damage, decreased fertility, and decreased antibody response to vaccines. Laboratory animals exposed to PFOS and PFOA have displayed changes in liver, thyroid, and pancreatic function, as well as developmental, immunological, and cancer effects. See Sources: US National Toxicology Program, (2016); C8 Health Project Reports, (2012); WHO IARC, (2017); Barry et al., (2013); Fenton et al., (2009); and White et al., (2011).

Numerous papers have been written regarding the use, application, health effects, remediation, and destruction of PFAS. See An alternative treatment method for fluorosurfactant-containing wastewater by aerosol-mediated separation (Ina Ebersbach, Svenja M. Ludwig, Marc Constapel, Hans-Willi Kling, Water Research, 101, (2016), pp 330-340).

Perfluorinated surfactants possess a high thermal and chemical stability and are not biodegradable. For example, perfluorooctane sulfonate (PFOS) fulfils the criteria of a PBT-substance (persistent, bioaccumulative and toxic) and has been listed under Annex B of the Stockholm Convention on persistent organic pollutants (POP) in 2010.

PFAS are stable because of their carbon-fluorine bonds and are unlikely to react or degrade in the environment. PFAS can attach to soil or sediment and leach to groundwater and surface water, which can impact drinking water sources. Long-chain PFAS are thought to be more likely to attach to soil and sediment than shorter chain PFAS. PFAS may bioaccumulate in plants, animals, and people at levels reported as nanogram/liter (ng/L).

More recently, manufacturers have developed compounds to replace commonly used PFAS that have been phased out of production. Replacement compounds may use fluorinated ether carboxylates to produce shorter-chain PFAS with similar properties as the long-chain compounds. One example of a replacement PFAS is GenX-a perfluoropolyether carboxylate surfactant previously detected in high concentrations in the Cape Fear River in North Carolina as a result of an industrial discharge.

It is no surprise then that the presence of PFAS contaminants in municipal wastewater, surface water, drinking water, and groundwater is a mounting risk.

### IV. TECHNICAL BACKGROUND

The subject of remediation of PFAS has become an important environmental issue. Current research approaches on the control of PFAS has been focused on separation and decomposition. Conventional treatment technologies are ineffective for PFAS removal. PFAS are generally resistant to chemical, physical, and biological degradation such as thermal-or UV-activated oxidation and ultrasonic irradiation. PFAS are generally resistant to hydrolysis, photolysis, and aerobic and anaerobic biodegradation., which limits many potential removal mechanisms. Dissolved air flotation, coagulation, flocculation, and sedimentation, granular media filtration (without activated carbon), oxidation, biofiltration, VOC air stripping and low-pressure membranes (UF and MF) provide no remediation.

Membrane filtration such as reverse osmosis (RO) and nanofiltration (NF) can effectively remove PFAS. However, the treatment cost is considerable for plants treating large volumes of water and is impractical as membrane filtration produces a large PFAS concentrate stream (approximately 10-25% of the treated water volume). At the moment, there is a lack of cost-effective way of treating the large water streams economically.

Due to their high chemical stability, perfluorinated surfactants resist advanced oxidation processes (AOP). (See Comparative study of PFAS treatment by UV, UV/ozone, and fractionations with air and ozonated air, Dai, X, Xie, Z, Dorian, B, Gray, Stephen, and Zhang, Jianhua, Water Re-search and Technology, 5, (2019) pp. 1897-1907).

PFAS may be partially degraded by means of in situ chemical oxidation (ISCO), UV/H₂O₂ and O₃ at pH>11, whereas no or only minor degradation was observed using UV, HO, H₂O₂/Fe₂ or O₃/H₂O₂ (See An alternative treatment method for fluorosurfactant-containing wastewater by aerosol-mediated separation, Ina Ebersbach, Svenja M. Ludwig, Marc Constapel, Hans-Willi Kling, Water Research, 101, (2016), pp 330-340).

Thermal treatment can be effective. However, very high temperatures are needed (greater than 1,770 degrees F.) for complete destruction, thereby making ex-situ treatment either impracticable or very expensive.

Electrochemical oxidation (EO) has been used to mineralize PFAS molecules. Work has shown EO to be effective at removing long chain PFOA and PFOS from the contaminated water. However, these are not mineralized but rather converted to shorter chain intermediates; PFHpA, PFHxA, PFPeA, PFBA and PFPrA. Total removal efficiency is less than 85%. Thus, EO is not truly a solution (see US 2019/0185351).

Electro-flotation has also been tested as a remedial treatment technology. Work has shown that a centrifugation is required to separate the PFAS flocs. However, the incorporation of centrifugation does not lend itself to the treatment of very large volumes of contaminated water and increases the treatment cost significantly. Additionally, when the water matrix is high in hardness, pretreatment is required to avoid interference. Efficiency is less 95%. (see U.S. Pat. No. 9,937,172).

Foam fractionation has been utilized for removal of PFAS compounds from contaminated water and wastewater. Although somewhat effective for long-chain PFAS compounds (carbon number>6) it has been shown to be ineffective for low molecular weight (carbon number<6) PFAS compounds. The removal of short chain PFAS molecules can be achieved using co-surfactants, adding process complexity and cost. Increased treatment time does not improve removal with foam fractionation. Removal efficiency for short chain PFAS is typically <60%.

Ex situ sorption-based remediation processes, such as granular activated carbon (GAC) adsorption and anionic exchange resin (IXR) filtration have had success in treating these compounds. However, the user is left to deal with the large amount of spent GAC and/or IXR.

These treatment methods have technical and/or economic constraints, mainly due to high energy-consumption, severe reaction conditions and feasibility for low concentration PFAS wastewater.

### V. BRIEF SUMMARY OF DISCLOSURE

PFAS are from extensive sources in the environment, but exist in the environment with very low concentrations, usually ranging from nanogram level (ppt) to microgram level (ppb) in a water body, and up to milligram level (ppm) in a heavily polluted water body (such as leachate). When the above treatment technologies are directly used for treating water, energy consumption is high and efficiency is low, so the above technologies are difficult to be applied at a large scale. Previous practitioners have taken the route of pre-treating the polluted water, concentrating the perfluorinated compounds (PFCs) in the water body and thus reducing the amount of water for treatment. This process is very time-consuming with complicated subsequent processing and is expensive.

In accordance with the disclosure, it is possible to treat low PFAS concentration solution, less than 1000 ppt, effectively and at low cost. The process is equally effective for higher PFAS concentration solutions.

The present system is configured to achieve the predetermined EPA threshold for drinking water limits set at 4 parts per trillion for PFOA and PFOS and of 10 ppt (each) on three other categories of per-and polyfluoroalkyl substances (PFAS) in drinking water, including perfluorononanoic acid (PFNA), perfluorohexane sulfonate (PFHxS), and “GenX” chemicals. GenX chemicals are made by the Chemours Co., which owns the trade name, to produce fluoropolymers used in semiconductor chips. GenX chemicals may include Hexafluoropropylene Oxide (HFPO) Dimer Acid and its Ammonium Salt.

In accordance with the disclosure, the untreated liquid containing PFAS, first undergoes a primary treatment with gelling aids rendering the PFAS molecules more electroactive as a microgel. The electroactive PFAS microgel from the primary stage then undergo a secondary electrochemical oxidation and/or advanced oxidation process (AOP)/UV stage that reduces the carbon chain length of the PFAS being treated. This is followed by a tertiary electrochemical coagulation stage to form micro-hydroflocs. Short chain PFAS molecules are readily adsorbed, and possibly absorbed, into the porous hydrofloc. Finally, a fourth aeration stage is introduced to separate the micro hydroflocs and to produce macroflocs which can be easily floated off to produce a water substantially free of PFAS.

The process is illustrated in detail in FIG. 1.

### Primary Stage

In accordance with the disclosure, the PFAS treatment comprises a primary pretreatment stage for treating water contaminated with low levels of PFAS. The method may comprise introducing contaminated water from a source of water contaminated with a concentration of PFAS to an inlet of a pretreatment tank. The pretreatment tank accepts and contains the untreated liquid from the untreated liquid input and allows for the addition of one or more gelling aid from the chemical tanks holding the gelling aid chemicals.

In some embodiments, the untreated liquid and one or more gelling aids are mixed and combined in the pretreatment tank to produce an electroactive microgel. Mixing is done using devices such as mechanical mixing devices (rotating paddle, fan, or impeller blades), aeration (flow-through mixing device, such as a venturi and/or bubble aerator) or a hydraulic mixing device.

In other embodiments, the untreated liquid and one or more gelling aid are mixed in-line with a static mixer or transfer/mixing pump.

In accordance with the disclosure, gelling agents are defined as materials or mixtures of materials, organic and/or inorganic, that reversibly bind through weak chemical or physical interactions to form a space-spanning gel network. More specifically they include hydrophobic associative polymers (HAP) containing hydrophobic side chains with excellent salt resistance. They bind with the hydrophobic tails of the PFAS molecules in aqueous solution to form a microgel that, when subjected to electro-oxidation, forms a microgel which is electroactive. FIG. 2 shows the mechanism of PFAS-gelling agent interaction to form a microgel.

Other useful space-spanning gel networks include crosslinked polymers where one or more crosslinkers are used to form the gel network. Crosslinkers can be metal ions or complexes, organic molecules, or mixtures thereof. Examples of organic crosslinkers are dicarboxylic acids. Examples of inorganic crosslinkers are metal ions: Ca²⁺, Ba²⁺, Cu²⁺, Fe²⁺, Zn²⁺

The hydrophobicity of the crosslinked HAP polymers improves the electrochemical oxidation of the PFAS at the surface of the anode or anodes surface used during the electrochemical oxidation process. The HAP-PFAS microgel is termed electroactive as it adsorbs on the hydrophobic anode surface more readily, thus allowing for the electro-oxidation process to occur more efficiently.

### Secondary Stage

In some embodiments, the PFAS treatment comprises a secondary electrochemical oxidation stage.

The method may further comprises treating the contaminated water containing the electroactive microgels from the outlet of the primary stage in a secondary electrochemical oxidation stage to produce a water substantially free of PFOA and PFOS but still containing PFAS molecules and intermediates.

The fact that the PFAS mineralization reaction does not need to be driven to completion is advantageous as there is an economic savings in power, reduced capitol equipment requirement and increased treatment capacity.

In some embodiments, the secondary stage comprises an advanced oxidation process (AOP) reactor. For example, the AOP may involve a UV/H₂O₂, O₃, H₂O₂/Fe²⁺ or O₃/H₂O₂ or UV-persulfate treatment.

In some embodiments, the PFAS treatment comprises the simultaneous or sequential combination of a secondary electrochemical oxidation stage and a secondary advanced oxidation process (AOP) stage.

In some embodiments, the PFAS treatment comprises a simultaneous or sequential combination of secondary electrochemical oxidation stage and an ultraviolet (UV) stage.

In all embodiments, the wavelength of the UV light is 100-400 nm. Ti₄O₇ is a known catalyst for UV treatment.

In some embodiments, the secondary stage comprises an electro-oxidation system, such as an electrochemical cell or multiple electrochemical cells.

In some embodiments the UV lamp is incorporated within the electrochemical cell as a single unit.

In some embodiments, the electrochemical cell involves a boron doped diamond (BDD) anode. In some embodiments, the electrochemical cell involves a dimensionally stable anode (DSA) anode.

In some embodiments, mixed metal oxides anodes (such as RuO₂ (ruthenium oxide), IrO₂ (iridium oxide), SnO (tin oxide) and/or PtO₂ (platinum oxide) in combination with another metal oxide, typically titanium dioxide), or boron doped diamond (BDD), or a combination thereof are used.

In certain embodiments, the electrochemical cell involves a Magneli phase titanium oxide anode, in particular a Tiₙ, O₂ₙ₋₁ (n=4-10) electrode. An exemplary electrode is Ti₄O₇. The term “Magneli-phase titanium oxide” refers to a titanium oxide having general formula TinO₂ₙ₋₁, for example, Ti₄O₇, Ti₅O₉, Ti₆O₁₁, or a mixture thereof. In an embodiment, the Magneli-phase titanium oxide may be Ti₄O₇. In other embodiments, the Magneli-phase titanium oxide may be a mixture of Magneli-phase titanium oxides.

In some embodiments, the cathode of the electrochemical cell is made of a stainless steel, nickel alloy, or titanium.

In some embodiments, the electrochemical cell comprises an electrolyte comprising at least one of hydroxide, sulfate, nitrate, and perchlorate.

### Tertiary Stage

In some embodiments, the PFAS treatment comprises a tertiary electrochemical coagulation stage.

The method may further comprises treating the contaminated water from the outlet of the secondary stage in a tertiary electrochemical coagulation stage to produce a product water wherein the PFAS molecules have complexed with the micro hydroflocs produced by electrochemical coagulation.

In various embodiments, during the electrochemical coagulation, an anode of electrodes can be made of a material containing aluminum, iron, zinc, copper, magnesium, or any alloy(s) thereof.

In various embodiments, for electrochemical coagulation, the preferred power supply is a DC electrolysis system but can include any suitable other system such as pulse electrolysis or AC to DC power supply.

In various embodiments, the DC electrolysis can supply a current density ranging from about 5 mA/cm² to about 300 mA/cm², a spacing between electrodes ranging from about 2 mm to about 50 mm, and an electrolysis time ranging from about 10 min to about 90 min.

In some embodiments, one or more micro-flocculating aids can be added to the secondary stage water as it enters the tertiary stage. Mixing is done utilizing a static in-line mixer and/or transfer/mixing pumps.

In accordance with the disclosure, micro-flocculating agents are defined as materials or mixtures of materials, organic and/or inorganic, that reversibly bind through weak chemical or physical interactions to form a bridged network. More specifically they include highly crosslinked micropolymers or inorganics particles such as colloidal silica with particle diameters less than 400 nm. The negative surface charge of the particles allows the particles to flocculate with positively charged organic polymers, metal flocs and particles via both bridging and charge reduction. The colloidal particles bind with micro-hydroflocs that are easily removed when subjected to air flotation. FIG. 3 depicts the process of bridging flocculation, where in (A) the negatively charged, colloidal silica is added to the positively charge micro hydrofloc with increase of floc size progressing from (B) to (D).

### Fourth Stage

In some embodiments, the PFAS treatment comprises a fourth, micro hydrofloc flotation stage to separate and drain the flocs to form a macrofloc sludge which can be further processed.

In some embodiments, the last stage having an inlet from the third stage in which the micro hydroflocs are floated via air or convection flotation to form a sludge and a treated water substantially free of all PFAS molecules.

In some embodiments, the sludge is further drained and compressed to form a higher solids sludge and a filtrate which may be sent back to the pretreatment tank. The final process being preferably a filter press or sludge press.

In some embodiments, the contaminated PFAS water is treated in batch mode through the treatment stages.

In some embodiments, the contaminated PFAS water is treated in continuous flow through the treatment stages.

In some embodiments, the contaminated PFAS water is treated in a combination of batch and continuous flow mode through the treatment stages.

In various embodiments, the aqueous solution can have a pH value ranging from about 3 to about 11.

In various embodiments, the PFAS in the aqueous solution can have a mass concentration >1 ng/L (1 ppt) to about 100 g/L (100 ppm) =1%.

In various embodiments, the PFAS can include at least one compound selected from perfluoroalkyl acids (or their salts) having about 4 to about 20 carbon atoms and precursors of these perfluoroalkyl acids/salts. Examples are: perfluorooctanoic acid (PFOA), perfluorooctane sulfonic acid (PFOS), perfluorononanoic acid (PFNA), perfluorodecanoic acid (PFDA), perfluorooctane sulfonyl fluoride (POSF), fluorotelomer alcohol (8:2 FTOH), N-ethyl perfluorooctane sulfonyl fluoride, N-ethyl perfluorooctane sulfonamido acetic acid, and 1H, 1H, 2H, 2H-perfluorooctane sulfonic acid.

The electrochemical contaminant remediation systems and methods described herein advantageously remove contaminants from water rapidly and efficiently. Moreover, the systems and methods described herein are particularly useful for remediating persistent, chemically stable contaminants such as PFAS.

While electrochemical remediation systems exist for the treatment of PFAS and other recalcitrant materials, they are limited by their ease of use and/or cost of application. For example, centrifugation is difficult to implement in large scale. Although most electrochemical remediation systems are effective at removing long chain PFOA and PFOS from the contaminated water, they do not truly “mineralize” these long chain PFAS. Studies have shown that these are not mineralized but rather converted to shorter chain intermediates; PFHpA, PFHxA, PFPeA, PFBA and PFPrA (see US 2019/0185351). Lastly, the rate of contaminant destruction by existing systems and methods is very slow and inefficient.

In accordance with one or more embodiments, systems and methods disclosed herein do not require a concentrated PFAS stream for enhanced PFAS removal.

To date, the art has focused mainly on destruction via electrochemical oxidation rather than the use of electrochemical oxidation to “precondition” the PFAS molecules in water for enhanced reactivity with “electrochemical coagulation” to form micro hydroflocs which can be easily removed from solution. Recent electro-flotation work (U.S. Pat. No. 9,957,172 and US appl. 2015/0360975) has made little use of the combined synergies of electrochemical oxidation and electro-chemical coagulation. Further, the art has not discussed the use of gelling agents to improve the electrochemical oxidation of PFAS molecules at the surface of an anode.

A recent publication (US 2023/0365440) has made use of cationic conditioning agents to achieve total removal of PFAS from contaminated water using electrochemical remediation. No data was presented other than a three-fold increase in kinetic decay rates. Cationic conditioning agents are ill suited for PFAS remediation, in particular PFAS waters having high concentrations of other anionic contaminants such as suspended particles, dissolved organic molecules (e.g. BOD, humic acid), other anionic contaminants and large particles. These are all present in water and particularly in leachate water sources. Chemistries cited in the reference are also used to “clarify” water through coagulation and flocculation. Thus, a large proportion of the added conditioning aid is not targeting the PFAS molecules but rather other solution contaminants. As the authors of reference US 2023/0365440 used leachate as their test matrix, it is believed that PFAS reduction was not due to electro remediation but rather through the mutual flocculation of PFAS onto the suspended solids present in their pretreatment with lime and ferric chloride and the polydadmac. In other words, the PFAS was removed in the clarification process. Regardless, the use of cationic conditioning aids adds complexity and cost to the treatment. The use of anionic, hydrophobically associative, micro-flocculating agents, such as polymer microparticles or colloidal silica, enhances the electrochemical coagulation and flotation of the produced flocs process.

The systems and methods described in this disclosure do not make use of charge neutralization but rather hydrophobic bonding and association which is not affected to any large degree by other solution contaminants and is easily implementable. The systems and methods described improve the rate of PFAS contaminant removal which increases the efficiency of the reactors, thereby improving throughput, performance, and/or reducing electrical requirements of the electrochemical reactor such as power and voltage.

### VI. BRIEF DESCRIPTION OF DRAWINGS

The features of the application can be better understood with reference to the drawings described below. The drawings are not necessarily to scale, emphasis instead generally being placed upon illustrating the principles described herein. In the drawings, like numerals are used to indicate like parts throughout the various views.

In FIG. 1, the overall progress from Stage 1 to Stage 4 of the treatment method is shown. For illustrative purpose, the chemical and physical reactions are illustrated for each stage.

In FIG. 2, the mechanism of the hydrophobically associative polymer (HAP) binding with the PFAS molecules in water is shown. The HAP-PFAS complex adsorbs more readily on the surface of the anode.

In FIG. 3, the mechanism of micro hydrofloc aggregation using nanoparticles is shown. The micro hydroflocs aggregate to form larger flocs which are readily removed through flotation.

In FIG. 4, an example of a water soluble hydrophobically associative polymer is shown.

In FIG. 5, an example of an electrochemical oxidative cell is shown.

In FIG. 6, the photodegradation mechanism of PFOA degradation by the UV/S₂O₈ process is illustrated.

In FIG. 7, an example of an electrochemical coagulation cell is shown.

In FIG. 8, illustrates PFAS adsorbed via hydrophobic interactions on the surface of the micro hydrofloc via the hydrophobic PFAS “tail”.

In FIG. 9, the composition of a mixed landfill leachate is plotted as a pie chart. The majority of the PFAS composition is short chain PFAS.

In FIG. 10A, an example of an Electrochemical Oxidation Cell set-up is shown.

In FIG. 10B, an example of a Photochemical Oxidation Cell set-up is shown.

In FIG. 10C, an example of an Electrochemical Coagulation Cell set-up is shown.

In FIG. 11, the composition of the PFAS compounds in leachate is shown after electrochemical oxidation.

In FIG. 12, the composition of the PFAS compounds in leachate is shown after photochemical oxidation.

In FIG. 13, the composition of the PFAS compounds in leachate is shown after electrochemical coagulation and treatment with colloidal silica flocculation.

FIGS. 14A and 14B are pictures of micro hydroflocs before and after treatment with colloidal silica or hydrophobically associative polymer.

In FIG. 15, the composition of the PFAS compounds in leachate is shown after electrochemical coagulation and treatment with hydrophobically associative polymer.

In FIG. 16, the composition of a mixed landfill leachate used in the examples of the disclosure is tabulated. The majority of the PFAS composition is short chain PFAS.

In FIG. 17, the composition of the PFAS compounds in leachate is shown after electrochemical oxidation; after photochemical oxidation; after electrochemical coagulation and treatment with colloidal silica flocculation; and after electrochemical coagulation and treatment with hydrophobically associative polymer.

In FIG. 18, the table shows that, after 10 hours of the photochemical oxidation, the removal rate of the long chain PFAS molecules was >66%. The overall removal of PFAS (long and short chain) was >70%.

FIG. 19 shows the results of treating micro-hydroflocs using colloidal microparticulate flocculation. The removal rate of the PFAS molecules, long and short, was >97%.

FIG. 20 shows the results of treating micro-hydroflocs formed from using hydrophobically associative polymer (HAP) flocculation. After 5 minutes, the removal rate of the PFAS molecules, long and short, was >90%.

### VII. DETAILED DESCRIPTION OF THE INVENTION

This disclosure is not limited to the types of negatively charged and/or fluorinated compounds being treated. Common PFAS such as perfluorooctanoic acid (PFOA) and/or perfluorooctane sulfonic acid (PFOS) may be removed from water. The U.S. Environmental Protection Agency (EPA) developed revised guidelines in May 2024 of a combined threshold for drinking water limits set at 4 parts per trillion for PFOA and PFOS and of 10 ppt (each) on three other categories of per-and polyfluoroalkyl substances (PFAS) in drinking water, including perfluorononanoic acid (PFNA), perfluorohexane sulfonate (PFHxS), and “GenX” chemicals.

### Pretreatment on Contaminated Water

In accordance with one or more embodiments, a primary stage may include a pretreatment of the contaminated water. The primary stage having an inlet fluidly connectable to the source of water contaminated with PFAS and an outlet having which is fluidly connectable to the inlet of a secondary electrochemical oxidation stage inlet.

In some embodiments, the untreated liquid and one or more gelling agents are mixed and combined in the pretreatment tank to produce an electroactive solution in the pretreatment tank. Mixing is done using devices such as mechanical mixing devices (rotating paddle, fan, or impeller blades), aeration (flow-through mixing device, such as a venturi and/or bubble aerator) or a hydraulic mixing device.

In other embodiments, the untreated liquid and adjuvant(s) are mixed in-line with a static mixer or transfer/mixing pump.

In accordance with the disclosure, gelling agents are defined as materials or mixtures of materials, organic and/or inorganic, that reversibly bind through weak chemical or physical interactions to form a space-spanning gel network. More specifically they are hydrophobic associative polymers (HAP) containing hydrophobic side chains with excellent salt resistance. They bind with PFAS molecules in aqueous solution to form a microgel that, when subjected to electro-oxidation, forms a micro gel which is electroactive.

In accordance with the disclosure, the microgels are hydrophobically attracted to, and are theorized to more readily adsorb to and/or be transported such that they are proximate to an electrode surface of the electrochemical reactor, thereby facilitating electron transfer from/to the contaminant and electrochemical degradation/destruction thereof. Because hydrophobic attraction is useful for forming the microgel, various hydrophobic moieties have been shown to have significant effects with respect to PFAS attraction to the surface of the anode.

In accordance with the disclosure, hydrophobically associative polymers (HAP) can be further defined as natural or synthetically derived water-soluble polymers containing a small number of oil-soluble or hydrophobic groups. In aqueous solution, hydrophobic associations can dominate polymer conformation and, in turn, solution rheological properties. Hydrophobic associating polymers have a few hydrophobic groups in the hydrophilic main chain and tend to be cross-linked. When the concentration of polymer solution is not less than the critical association concentration (CAC) value, the hydrophobic groups which are blocky or randomly distributed on the molecule backbone tend to form a reversible supermolecular network (microgel) in aqueous solution by intermolecular hydrophobic association. Therefore, compared with traditional polymers, hydrophobic associating polymer solution behaves with better rheological properties, such as strong salinity tolerance, good shearing resistance and temperature resistance. In addition, hydrophobic associating polymers usually present interfacial activity and emulsification properties owing to the introduction of hydrophobic parts.

Hydrophobically associative polymers (HAP) form hydrogels in aqueous solution due to intermolecular association originating from the hydrophobic groups. Increasing the length or size of the hydrophobic group and/or group concentration and/or crosslinking lead to more elastic networks due to increased hydrophobic interaction. HAP bearing shorter hydrophobic groups give gels with relatively long linear response followed by strain hardening before shear thinning while the longer hydrophobic groups lead to formation of elastic but brittle gels with limited linear regime before shear thinning.

In accordance with the disclosure, hydrophobic associative polymers can be made with any starting water soluble cationic, non-ionic, or anionic polymer onto which hydrophobic groups are attached. Examples of hydrophobic pendant groups are, but not limited to, hydrophobic (meth) acrylic acid C4-8-alkyl esters, ethyl and methyl acrylates with C₂-C₂₀ pendant chains, lignins and modified lignin, lignosulfonates and carboxylates, hydrophobically modified celluloses, hydrophobically modified hemicelluloses and hydrophobically modified starches and sugars, hydrophobically modified polyacylamides, hydrophobically modified polyamines, hydrophobically modified polydadmacs, hydrophobically modified polyimines, and hydrophobically modified polyvinylalcohols. The polymer contains 0.0001 to 10 wt.-% of one or more hydrophobic groups.

In accordance with the disclosure, the hydrophobically associative polymers may be crosslinked with 0.0001 to 1.25 wt.-% of one or more ethylenically unsaturated cross-linkers, based on the total weight of monomers.

Other useful crosslinkers can be metal ions or complexes, organic molecules, or mixtures thereof. Examples of organic crosslinkers are dicarboxylic acids. Examples of inorganic crosslinkers are metal ions: Ca2+, Ba2+, Cu2+, Fe2+, Zn2+.

FIG. 4 depicts an example of a water soluble hydrophobically associative polymer.

In accordance with the disclosure, the secondary stage may include electrochemical oxidation and/or photochemical AOP.

### Electrochemical Oxidation

In accordance with the disclosure, in the electrochemical oxidation process, the CF₂ units in the PFAS molecule are gradually snipped off until the PFAS molecule is totally degraded. The mechanism for carboxylate PFAS molecule degradation/mineralization, such as PFOA, is shown in Equations 1-5.

FIG. 5 shows an example of an electrochemical oxidative cell. The system is a single or multi anode assembly surrounding a central cathode. The anodes are non-consumable dimensionally stable and have high oxidation potential. The reactor modules are modular and thus configurable for any number of process integrations. During electrochemical oxidation water treatment process, an electrical current between the cathode and the anode is applied. Applying current with an external power supply allows the two half-cell reactions of anodic oxidation and cathodic reduction of water, thus forming hydroxyls and oxidative species. As current furnished to the cell augments, the rate of oxidative species manufacture increases at the anode surface, therefore leading to the elevated remediation of the contaminants breaking-down the chemical bonds of organics.

In accordance with one or more embodiments, the anode may be constructed of a Magneli phase titanium oxide allowing for direct oxidation of PFASs on its surface. The reaction may generally be characterized as a Kolbe-type oxidation. The reaction initiates from direct oxidation of carboxylate ions to carboxylate radicals (Eq. 1) on a Ti₄O₇ surface by applying a sufficient positive voltage. The carboxylate radicals are subsequently decarboxylated to perfluoroalkyl radicals (Eq. 2). By coupling with hydroxyl free radicals which are anodically generated on the Ti₄O₇ surface, the perfluoroalkyl radicals are converted to perfluoro alcohols (Eq. 3) which further deflourinate to perfluoro carbonyl fluoride (Eq. 4) and finally hydrolyze to a perfluorocarboxylic as a byproduct by losing one carbon in the chain (Eq. 5). Reactions 1 to 5 may generally be repeated until all carbon from PFASs are eventually stripped off to inorganic CO₂, H+, and F−.

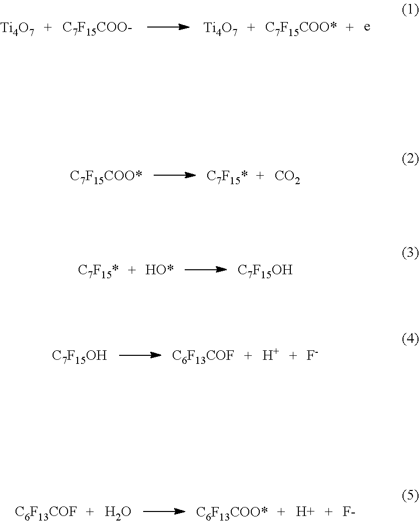

Similar to the PFOA degradation/mineralization process, PFOS, a sulfonate, and its degradation intermediates likely degrades via a combination of direct electron transfer and reaction with OH. The reaction may be initiated by transferring an electron from the sulfate head group of PFOS to the anode, to form C₈F₁₇SO₃* (Eq. 6). The C—S bond will then become extended and cleaved to form C₈F₁₇ and SO₃. (Eq. 7). Subsequently, SO₃ will transform to SO₄²⁻ in aqueous solution, while the produced C₈F₁₇* reacts with *OH to produce C₈F₁₇OH, and then reacts with another *OH with a hydrogen atom abstracted to generates C₈F₁₇O* (Eq. 8), rather than decompose to C₈F₁₇OH and HF*. C₈F₁₇O. can be easily cleaved to C₇F_{15*} and CO₂ (Eq. 9-11). By repeating this CF₂-unzipping cycle (C₈F₁₇* to C₇F₁₅*), the activated PFOS (C₈F₁₇*) can direct completely mineralize to CO₂ and HF over the porous Ti₄O₇ anode. All these processes can occur concurrently over the Ti₄O₇ anode surface because it is highly effective in both direct electron transfer and generating *OH.

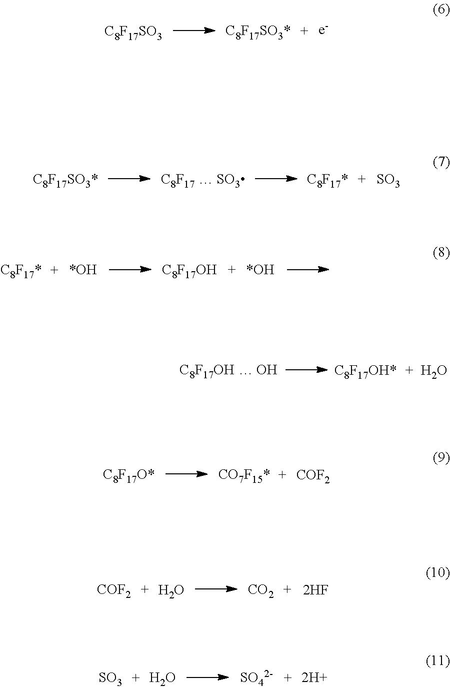

In accordance with one or more embodiments, electrochemical oxidation system may comprise an electrochemical cell used to degrade PFAS in water from larger molecules to smaller molecules. The electrochemical cell will include at least two electrodes, i.e., one cathode and one anode. A reference electrode may also be used, for example, in proximity to the anode.

In accordance with one or more embodiments, the cathode may be constructed of various materials which are selected based the environmental conditions, e.g., pH level, and specific process requirements (cleaning), and power requirements. Without limitation, the cathode may be made of stainless steel, nickel alloy, titanium, or any suitable dimensionally stable material.

In accordance with one or more embodiments, the anode may be constructed of a material characterized by a high oxygen evolution overpotential. Overpotential may generally relate to the potential difference (voltage) between a half-reaction's thermodynamically determined reduction potential and the potential at which a redox event is experimentally observed. The term may be directly related to an electrochemical cell's voltage efficiency.

In accordance with one or more embodiments, the anode may exhibit a preference for a surface reaction in water. Based on various physical characteristics and/or the chemical composition of the anode, water molecules may be repelled from the surface while non-polar organic pollutants may be easily absorbed. This may promote a direct oxidation reaction on the surface which may, for example, be particularly beneficial for the treatment of PFAS.

In accordance with one or more embodiments, the anode may be constructed of a Magnéli phase titanium oxide of the general formula TiₙO2ₙ₋₁, where n=4-10 inclusive. Magnéli phase titanium oxide anodes may have superior performance for inhibiting oxygen evolution compared to other anode materials. This may allow for the direct oxidation of PFAS on its surface.

In accordance with one or more embodiments, the anode may be formed in a variety of shapes, for example, planar or circular. In at least some preferred embodiments, the anode may be characterized by a mesh or foam structure, which may be associated with a higher active surface area, pore structure, and/or pore distribution.

In accordance with one or more embodiments, electrochemical oxidation may be used simultaneously with photochemical UV irradiation. Ultraviolet (UV) treatment with electrochemical oxidation has shown to be effective in breaking down PFAS molecules. Ti₄O₇ is a catalyst for UV treatment.

In accordance with one or more embodiments the supporting electrolyte chosen for the electrochemical oxidation may be chosen to minimize energy consumption required in the primary stage. Electrolytes may include any of Cl⁻, SO₄²⁻, NO3-, ClO₄- and OH- ions. Typical solution concentration of electrolytes is shown in Table 1.

In accordance with one or more embodiments, the current density applied to the anodes is typically 2 mA/cm² to 1000 mA/cm², more typically 5-60 mA/cm².

TABLE 1
Typical Solution Concentration of supporting Electrolytes

| Electrolyte | Concentration (mM) |
|---|---|
| NaCl | 10-100 |
| Na2SO4 | 1-100 |
| NaOH | 1-100 |
| NaNO2 | 1-10 |

### Photochemical AOP

In accordance with one or more embodiments, a primary stage may include a photochemical advanced oxidation process (AOP). The photochemical advanced oxidation process (AOP) system may comprise one or more UV lamps, each emitting light at a desired wavelength in the UV range of the electromagnetic spectrum. For instance, according to some embodiments, the UV lamp may have a wavelength ranging from about 100 to about 400 nm.

In accordance with one or more embodiments, the Photochemical advanced oxidation process (AOP) will include a chemical feed system by which, but not limited tom H₂O₂, O₃, Fe₂, O₃/H₂O₂ or persulfate are added to the contaminated PFAS water stream.

In accordance with one or more embodiments, a PFAS elimination stage may include photochemical treatment to degrade the PFAS. Ultraviolet (UV) treatment combined with H₂O₂, O₃, Fe₂, O₃/H₂O₂ or persulfate has shown to be effective in breaking down PFAS molecules.

According to various aspects, the combination of persulfate with UV light is more effective than using either component on its own.

In some embodiments the UV lamp is incorporated within the electrochemical cell as a single unit.

In accordance with one or more embodiments, the source of contaminated water is dosed with the oxidant and then exposed to a source of UV light. The chemical dosage and UV light dosage are predetermined for each water sample but are preferably above 50 mJ/cm².

UV treatments exist to degrade and remove PFAS (see “Validation of UV/persulfate as a PFAS treatment of Industrial Wastewater, Uwayezu et al., Journal of Water Process Engineering, 53 (2023), 1036”). The mechanism of degradation/mineralization involved in photochemical AOP is more complex. The oxidative degradation of PFAS has been reported to follow a pattern involving, firstly electron transfer, which could be initiated by SO₄*⁻, h⁺ or *OH in photo-enhanced processes to give either radical species (PFASs*) or anionic radical (PFASs*⁻). This is followed by C—CO₂H bond cleavage in PFCAs (decarboxylation) or C—SO₃H bond cleavage in PFSAs (desulfonation) yielding unstable perfluoroalkyl radicals (CnF₂ₙ₊₁)*. In photolytic processes, the direct cleavage of the C—CO₂H and C—SO₃H is achieved by the absorption of light usually in the VUV range. The unstable perfluoroalkyl radical can either react with water to form a thermally unstable alcohol CnF₂ₙ₊₁OH or react with molecular oxygen generated in the system to yield perfluoroperoxy radical, which then undergoes a two-stage combination reaction with another perfluoroperoxy radical to yield the perfluorinated alcohol. The choice of the route to the formation of the unstable alcohol species is reportedly dependent on the type of system employed and the pH of the reaction system. The obtained alcohol then undergoes hydrogen fluoride elimination to form Cₙ₋₁F₂ₙ₋₁COF, followed by CF₂ elimination via hydrolysis to yield a shorter chain PFAS (Cₙ₋₁F₂ₙ₋₁COOH). This short chain PFAS then undergoes, repeatedly, the chain reactions leading to CF₂ elimination till complete mineralization is achieved. This mechanism is referred to as the decarboxylation-hydroxylation-elimination-hydrolysis (DHEH) pathway and it is the most probable pathway for explaining the degradation and defluorination of PFAS. The pathway is shown in FIG. 6.

### Electrochemical Coagulation

In accordance with one or more embodiments, a secondary stage may include an electrochemical coagulation stage comprising an electrochemical cell used to generate micro hydroflocs in aqueous solution. The electrochemical cell will include at least two electrodes, i.e., one cathode and one anode.

In accordance with the disclosure, micro hydroflocs are defined as nanocomposite materials that exhibit high adsorption capacity due to their large surface areas to provide targets for the flocculation of PFAS molecules. They are formed when metal ions such as Al, Zn or Fe ions or salts are added in sufficient dosages to form voluminous amorphous precipitates of hydroxides (e.g. Al micro hydrofloc in FIG. 1). Flocs quickly appear within few minutes of electrolysis and are gathered and removed by sedimentation and filtration.

In accordance with one or more embodiments, the cathode is made of a stainless steel, nickel alloy, titanium, or a suitable conductive material.

In accordance with one or more embodiments, the anode can be made of an iron, aluminum, magnesium, copper or zinc or any alloy(s) thereof.

In accordance with the disclosure, aluminum is the preferred anode.

In accordance with the disclosure, the preferred power supply is a DC electrolysis system but can include any suitable other system such as pulse electrolysis.

In various embodiments, the DC electrolysis system supply a current density ranging from about 5 mA/cm² to about 300 mA/cm², a spacing between electrodes ranging from about 2 mm to about 50 mm, and an electrolysis time ranging from about 10 min to about 90 min.

FIG. 7 shows an example of an electrochemical coagulation cell. The system applies an electrical current between the cathode and the anode via an external power supply to an electrochemical setup. The two half-cell reactions of anodic metal dissolution and cathodic reduction of water make possible the formation of coagulant chemicals. As current furnished to the cell augments, the rate of anodic metal dissolution and water reduction at the cathode surface augments, therefore leading to the elevated generation of coagulant. By controlling the pH of the reaction and the anodic metal used, it is possible to form micro hydroflocs that have either a positive or negative charge.

In accordance with one or more embodiments, a mechanism of using electrocoagulation generates micro hydroflocs including ferric hydroxide, aluminum hydroxide, copper hydroxide or zinc hydroxide and the like. The micro hydroflocs have a large specific surface area, have a large surface charge density (negative hydroxyl groups and/or positive metal coordination complexes) at the surface of the micro hydrofloc and are partially hydrophobic. PFAS molecules contain fluorine atoms which are known to be strongly hydrogen bonding with the hydroxyl groups at the surface of the micro hydrofloc. Furthermore, the PFAS can further be adsorbed via hydrophobic interactions on the surface of the micro hydrofloc via the PFAS “tail,” as shown in FIG. 8.

In accordance with the disclosure, by studying the interaction of PFAS with micro hydroflocs produced by electrocoagulation, the author has found that shorter PFAS molecules adsorb and/or absorb more readily onto the surface of the micro hydrofloc. Data indicate the shorter PFAS molecules are not only capable of adsorbing on the surface but also absorbing into the porous micro hydrofloc structure. For purposes of this disclosure, long-chain PFAS refers to PFCAs with eight or more carbons (seven or more carbons are perfluorinated) and PFSAs with six or more carbons (six or more carbons are perfluorinated). Short-chain refers to: PFCAs with seven or fewer carbons (six or fewer carbons are perfluorinated); PFSAs with five or fewer carbons (five or fewer carbons are perfluorinated)

The following Table depicts how the PFAS compounds are classified according to this definition:

| Number of Carbons | 4 | 5 | 6 | 7 | 8 | 9 | 10 | 11 | 12 |
|---|---|---|---|---|---|---|---|---|---|
| PFCAs | Short-chain PFCAs | | | | Long-chain PFCAs | | | | |
| | PFBA | PFPeA | PFHxA | PFHpA | PFOA | PFNA | PFDA | PFUnA | PFDoA |
| PFSAs | PFBS | PFPeS | PFHxS | PFHpS | PFOS | PFNS | PFDS | PFUnS | PFDoS |

| | |
|---|---|
| Short-chain PFSAs | Long-chain PFSAs |

The definition above was adopted by the U.S. Environmental Protection Agency on Dec. 30, 2009 (see EPA, Long-Chain Perfluorinated Chemicals (PFCs) Action Plan, dated Dec. 30, 2009). The above chart is from The Interstate Technology & Regulatory Council (ITRC) Technical/Regulatory Guidance on Pre-and Polyfluoroalkyl Substances (PFAS) (September 2020).
In the electrochemical coagulation process, PFAS is removed by adsorption of the PFAS generated metal (oxy) hydroxide flocs (micro hydroflocs). The PFAS molecules generated during the electrochemical coagulation process contaminants can physically or chemically adsorb on the (oxy) hydroxide flocs.

### The Reactions for Fe at the Anode Are:

### Anode Reactions:

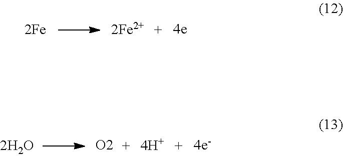

### Cathode Reactions:

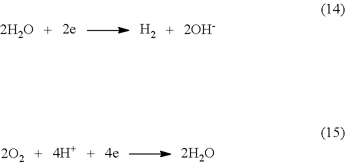

OH-production from the reaction increases the pH of the solution and influences the prevalence of different Fe (II)/Fe(III) hydroxide complexes in solution. Soluble Fe(II) is easily oxidized to insoluble Fe(OH)₃ in the presence of O₂, which is commonly dissolved in water. The flocs formed are typically cationic.

Electrochemical coagulation is able to produce flocs over a wider pH range. For Al, the influence of solution chemistry on floc formation during Al Electrochemical coagulation differs significantly from that of Fe Electrochemical coagulation. Although Al follows the same electro reactions as Fe (Egns. 12-15), Al is only converted to Al₃+ during electrolysis whereas Fe can transform from Fe₂+ to Fe₃+ under various conditions. At pH values >9, the monomeric anions Al(OH)₄ are the major species. Therefore, it is concluded that the electrochemical coagulation acts as a pH buffer. This is advantageous operationally as pH adjustment is not required before or during treatment in practical applications. Solution pH significantly impacts the efficiency of the electrochemical coagulation process. Due to the high specific surface area, micro flocs of Al(OH)₃ formed at a pH of 6-7 have a positive charge.

Furthermore, the production of a cationic Al micro hydrofloc in acidic conditions is advantageous. It was further discovered that if small amounts of silicious material, as for example colloidal silica nanoparticles, the micro hydroflocs are more persistent, and have a higher adsorption capacity for PFAS (FIGS. 1 and 3). Colloidal silicas are suspensions of fine amorphous, nonporous, and typically spherical silica particles in a liquid phase. There are many grades of colloidal silica, but all of them are composed of silica particles ranging in size from about 2 nm up to about 150 nm. The particles may be spherical or slightly irregular in shape and may be present as discrete particles or slightly structured aggregates. They may be partially hydrophobic. Colloidal silica surface charge is anionic but may be modified to be cationic.

Polymeric nanoparticles can also be used in the apparatus and methods according to the disclosure.

It has also been found that the use of Zn anode to form Zn micro hydroflocs is advantageous. Aluminum hydroxide flocs are mainly composed by hydrophilic colloidal aluminum hydroxide with small amount of hydrophobic tridimensional tactoids hydrated aluminum ions, whereas zinc hydroxide flocs exhibit a certain hydrophobicity.

Microflocculating agents useful in the apparatus and methods according to the disclosure can be categorized as high surface area materials having a particle size below 500 nm, for example, colloidal silica which may or may not form structures in aqueous solution, metasilicates, colloidal hydroxides, colloidal metal complexes, such as activated alumina. More specifically the microflocculating agent is mixed with contaminant containing water containing PFAS and micro hydroflocs to combines, complex, sorb, interacts, and/or bind with the PFAS containing micro hydroflocs to form stable macroflocs which are easily floated. Colloidal silica microflocculating agent are particularly advantageous as a coagulants or/and flocculant in water treatment as they aid in the removal of suspended solids and contaminants. Colloidal silica destabilizes colloidal particles and promotes their aggregation, facilitating their removal through sedimentation or flotation.

### Micro Hydrofloc Flotation

In some embodiments, separation of the formed PFAS macroflocs from a source of contaminated water may be achieved using floc flotation, where the macroflocs are floated off and removed from the water. Floc flotation is well known and is utilized in wastewater treatment plants, to remove solids, oils, and fats from the water. During floc flotation, gas bubbles rise through a vessel of contaminated water, forming a large floc that have a large surface area air-water interface.

In accordance with one or more embodiments, the sludge produced in the third stage is compressed and drained. This can be achieved by using any appropriate systems such as a filter press or sludge press.

In some embodiments, the sludge is further drained and compressed to form a higher solids sludge and a filtrate which may be sent back to the pretreatment tank. The final process being preferably a filter press or sludge press.

In some embodiments, the contaminated PFAS water is treated in batch mode through the treatment stages.

In some embodiments, the contaminated PFAS water is treated in continuous flow through the treatment stages.

In some embodiments, the contaminated PFAS water is treated in a combination of batch and continuous flow mode through the treatment stages.

In various embodiments, the aqueous solution can have a pH value ranging from about 3 to about 11.

In various embodiments, the PFAS in the aqueous solution can have a mass concentration >1 ng/L (1 ppt) to about 100 g/L (100 ppm).

A detailed description of the disclosed process is shown in the Figures.

FIG. 1 shows the overall progress from Stage 1 to Stage 4. For illustrative purpose, the chemical and physical reactions are illustrated for each stage. The figure describes in detail the progression of the reaction steps and compounds/aggregates/complexes formed as the process progresses.

FIG. 2 shows the mechanism of the hydrophobically associative polymer (HAP) binding with the PFAS molecules in water. The HAP-PFAS complex adsorbs more readily on the surface of the anode. The binding of the PFAS molecule to the HAP is driven by both adsorption and absorption.

FIG. 3 shows the mechanism of micro hydrofloc aggregation using nanoparticles. The micro hydroflocs aggregate to form larger flocs which are readily removed through flotation. Conditions are carefully controlled to form the micro hydrofloc which is most readily removed.

FIG. 4 shows an example of a water soluble hydrophobically associative polymer. HAP polymers can be configured for optimum efficacy.

FIG. 5 shows an example of an electrochemical oxidative cell. This depiction of a cell is for illustrative purposes only. Many other acceptable cell configurations are known to those of skill in the art.

FIG. 6 illustrates the photodegradation mechanism of PFOA degradation by the UV/S₂O₈ process. This is a general pathway.

FIG. 7 shows an example of an electrochemical coagulation cell. This depiction of a cell is for illustrative purposes only. Many other acceptable cell configurations are known to those of skill in the art.

FIG. 8 illustrates PFAS adsorbed via hydrophobic interactions on the surface of the micro hydrofloc via the hydrophobic PFAS “tail”. Absorption is prevalent for small chain molecules while adsorption dominates large chain molecules.

In FIG. 9, the composition of a mixed landfill leachate used in the examples of the disclosure is plotted as a pie chart. The majority of the PFAS composition is short chain PFAS. The data is tabulated in Table 1.

In Table 1, the composition of a mixed landfill leachate used in the examples of the disclosure is plotted as a pie chart. The majority of the PFAS composition is short chain PFAS. The data is plotted in FIG. 1.

FIG. 10A shows an example of an electrochemical oxidation cell set-up. Note the porous Magneli anode.

FIG. 10B shows an example of a photochemical oxidation cell set-up is shown. A 0.5 kW lamp was inserted.

FIG. 10C shows an example of an electrochemical coagulation cell set-up. The anode was composed of solid aluminum.

FIG. 11 shows the composition of the PFAS compounds in leachate after electrochemical oxidation. After 25 hours of the electrolysis reaction, the removal rate of the long chain PFAS molecules was >99%. The overall removal of PFAS (long and short chain) was 47%. However, we see an increase of short chain PFAS molecules from 57,000 ppm to 127,000 ppm. The increase is due to the degradation of the long chain PFAS molecules to short chain molecules.

Table 2 shows the composition of the PFAS compounds in leachate after electrochemical oxidation. After 25 hours of the electrolysis reaction, the removal rate of the long chain PFAS molecules was >99%. The overall removal of PFAS (long and short chain) was 47%. However, we see an increase of short chain PFAS molecules from 57,000 ppm to 127,000 ppm. The increase is due to the degradation of the long chain PFAS molecules to short chain molecules.

FIG. 12 shows the composition of the PFAS compounds in leachate after photochemical oxidation. After 10 hours of the photochemical oxidation, the removal rate of the long chain PFAS molecules was >66%. The overall removal of PFAS (long and short chain) was >70%. Unlike electrochemical oxidation, photochemical oxidation was very effective at removing PFAS. Large chain PFAS molecules were not degraded to the same extent to short chain PFAS as in the electrochemical oxidation process.

Table 2 shows the composition of the PFAS compounds in leachate after photochemical oxidation. After 10 hours of the photochemical oxidation, the removal rate of the long chain PFAS molecules was >66%. The overall removal of PFAS (long and short chain) was >70%. Unlike electrochemical oxidation, photochemical oxidation was very effective at removing PFAS. Large chain PFAS molecules were not degraded to the same extent to short chain PFAS as in the electrochemical oxidation process.

FIG. 13 shows the composition of the PFAS compounds in leachate after Electrochemical Coagulation and treatment with Colloidal Silica flocculation. After 5 minutes, the removal rate of the PFAS molecules, long and short, was >97%.

Table 2 shows the composition of the PFAS compounds in leachate after Electrochemical Coagulation and treatment with Colloidal Silica flocculation. After 5 minutes, the removal rate of the PFAS molecules, long and short, was >97%.

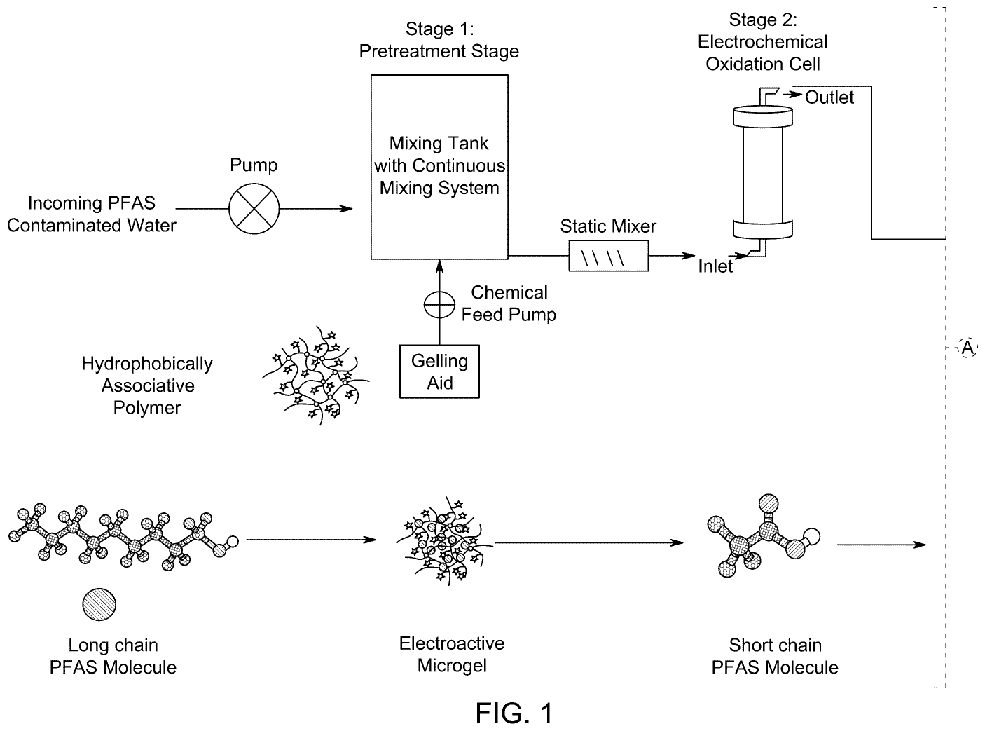

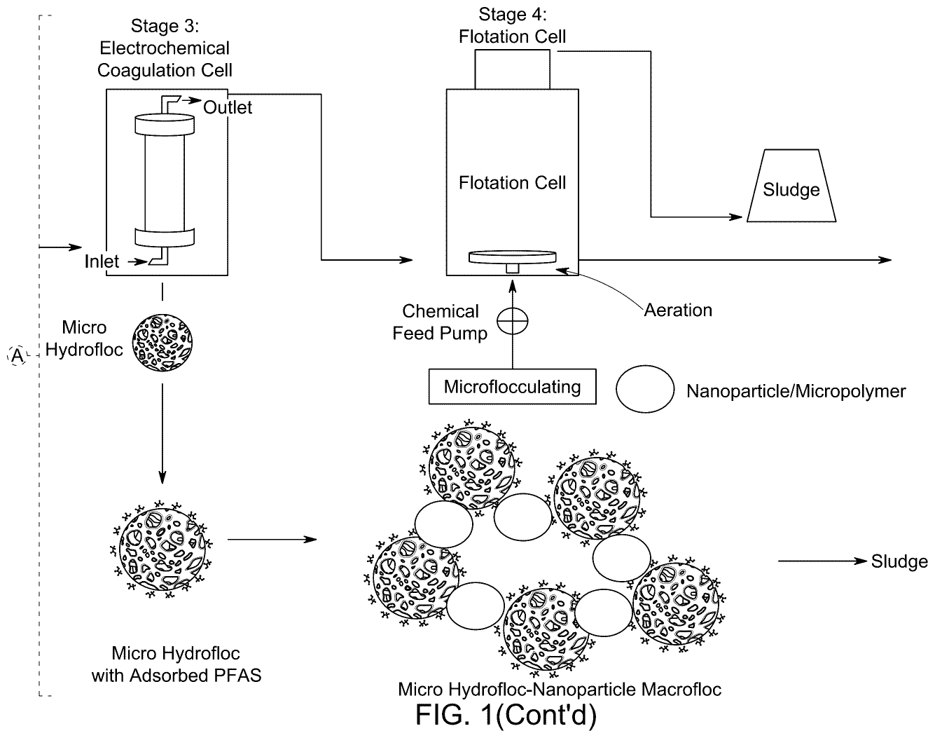

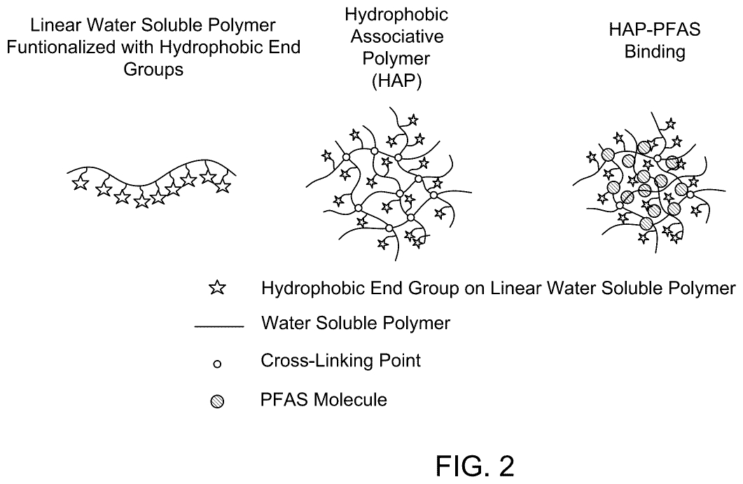

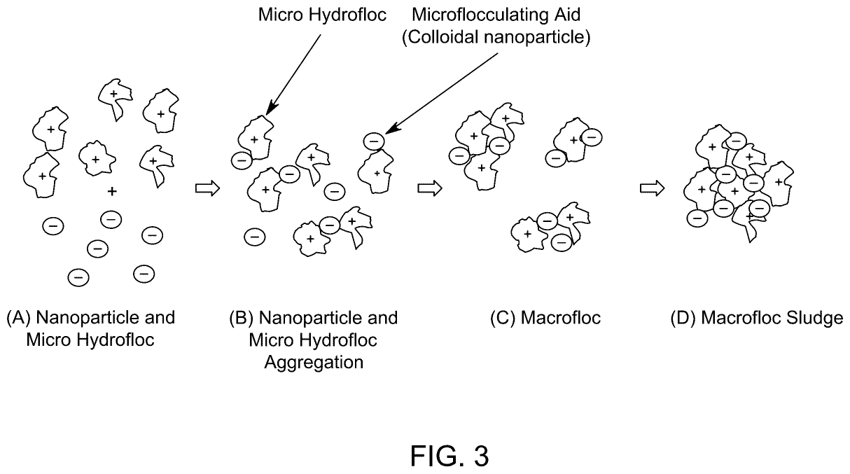

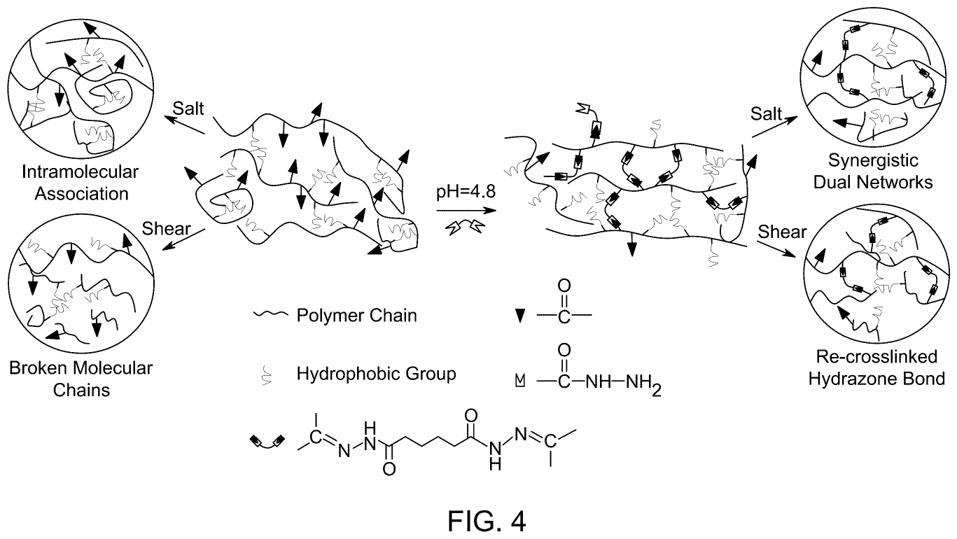

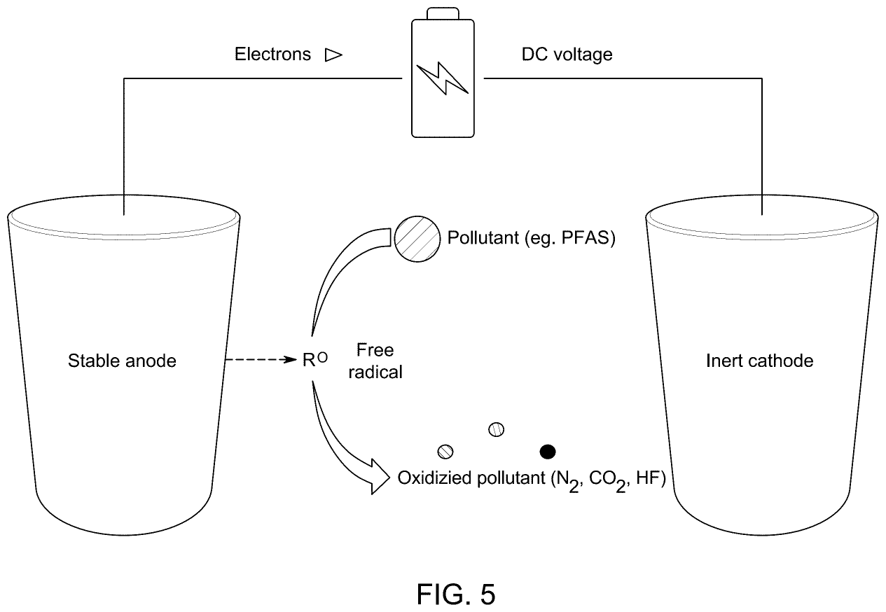

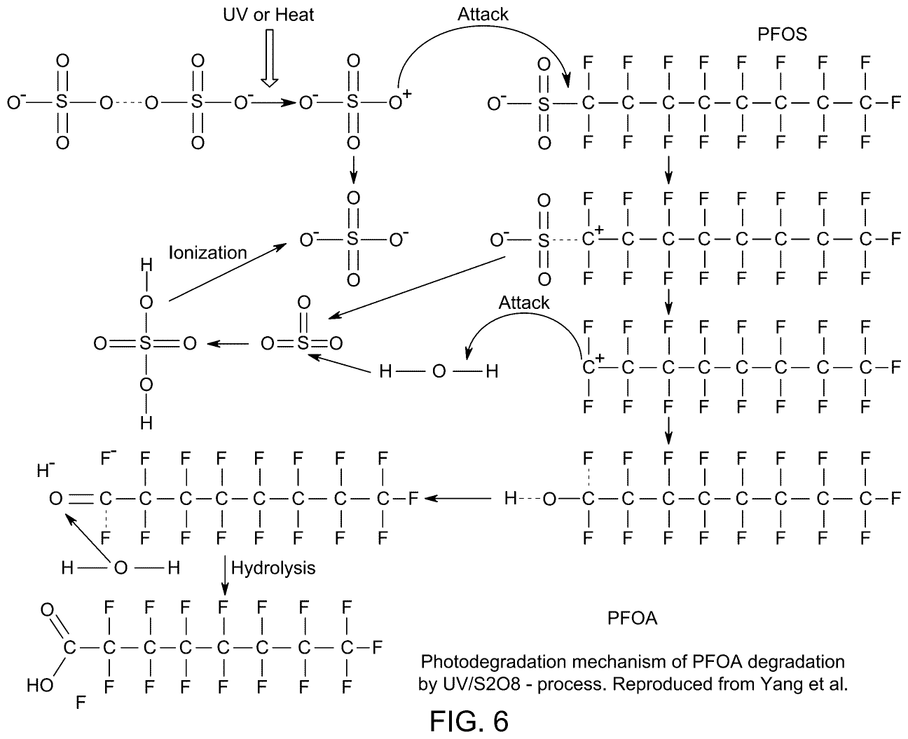

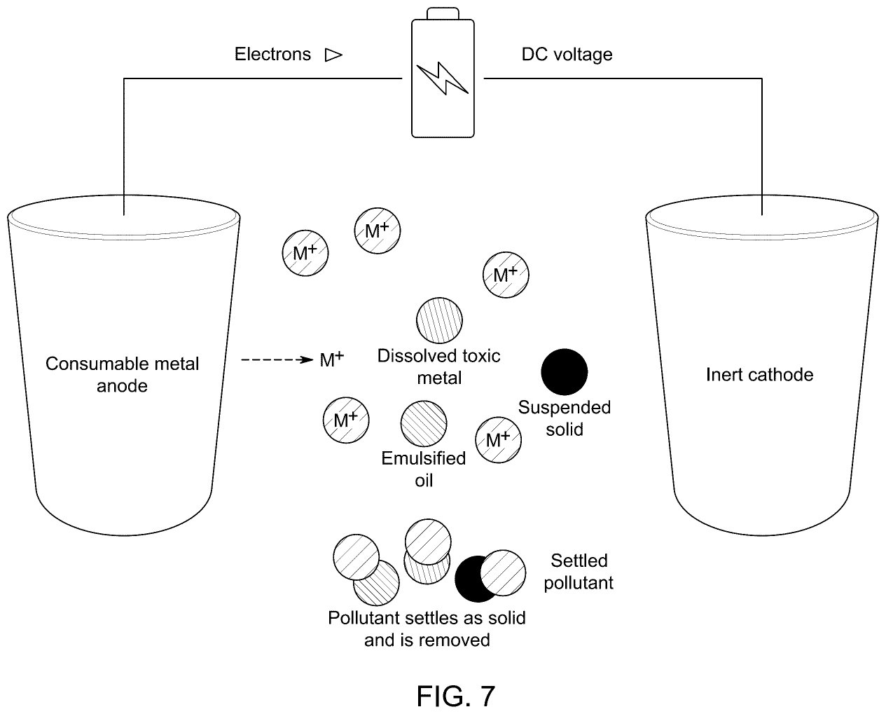

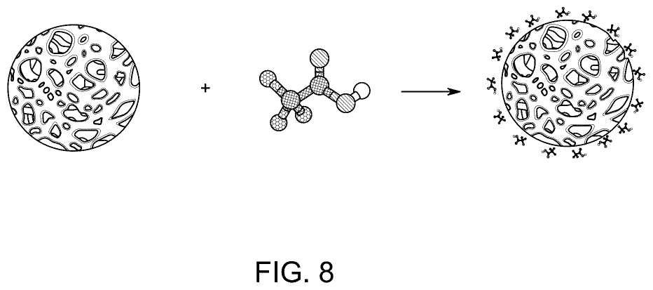

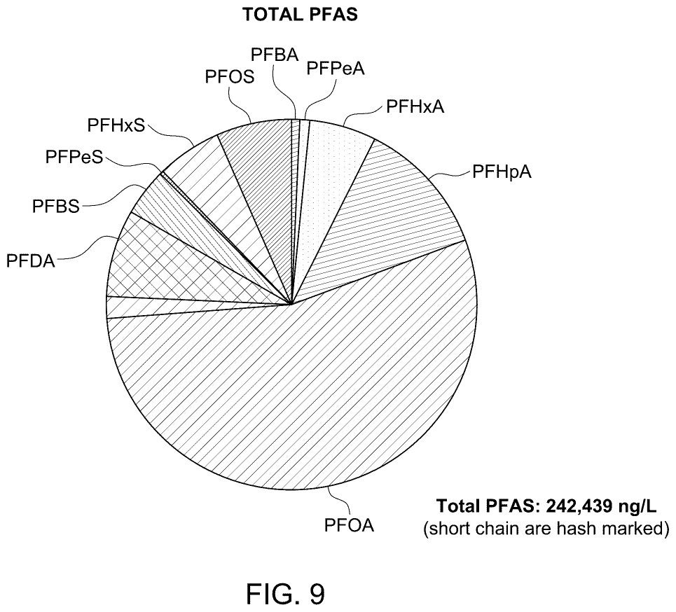

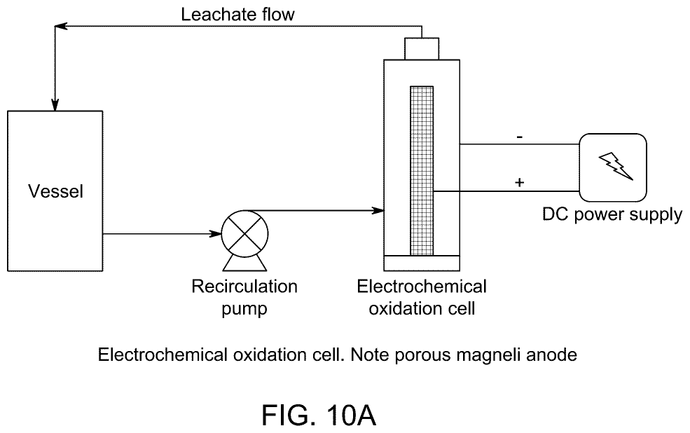

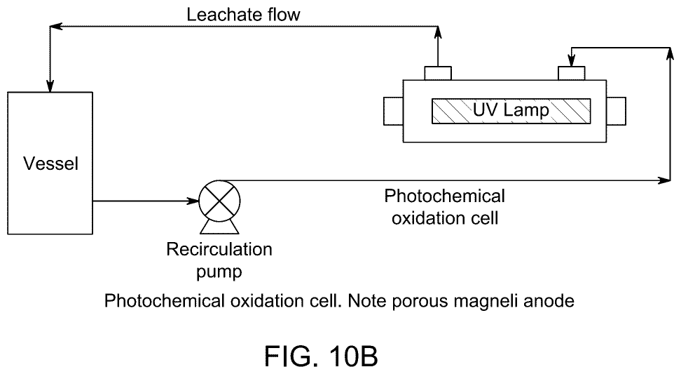

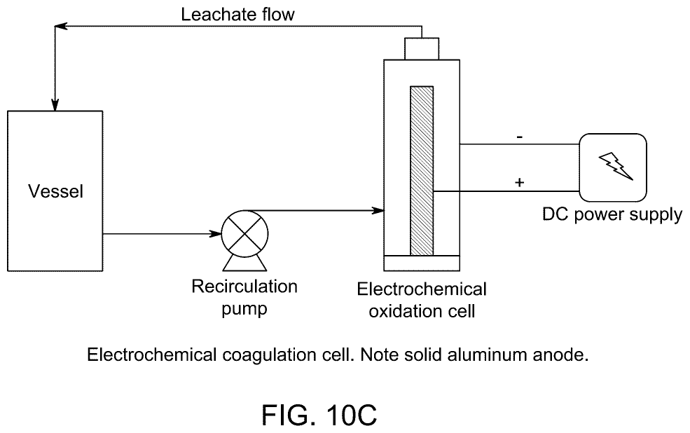

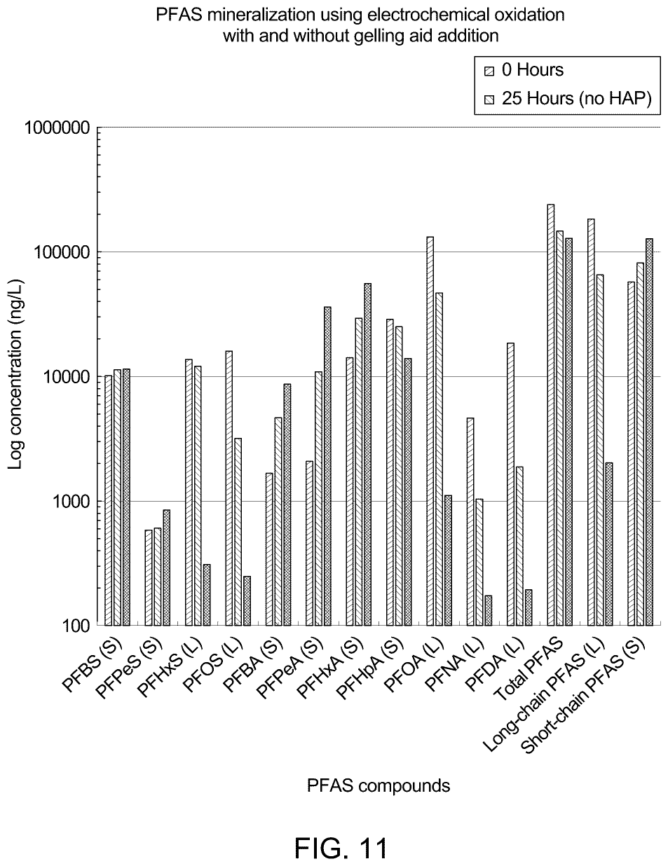

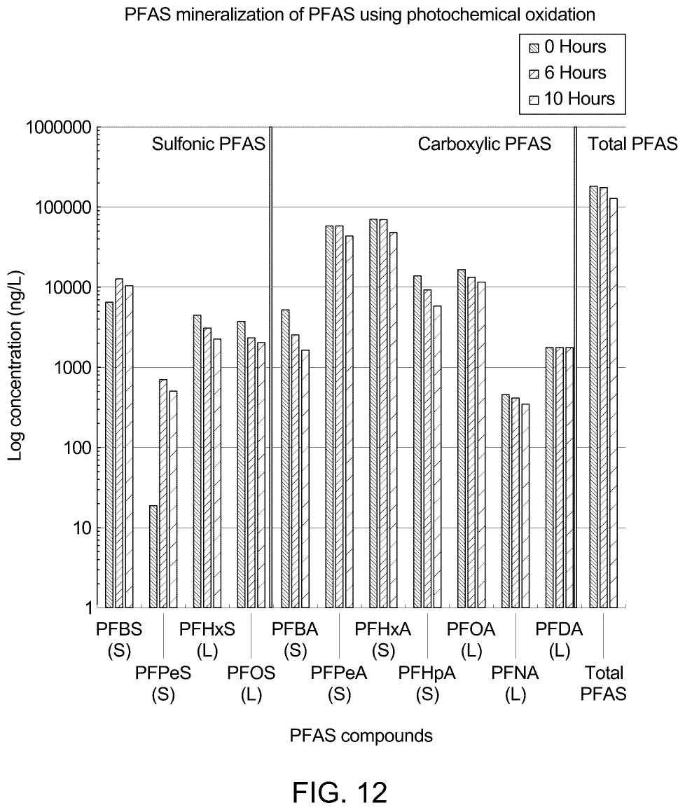

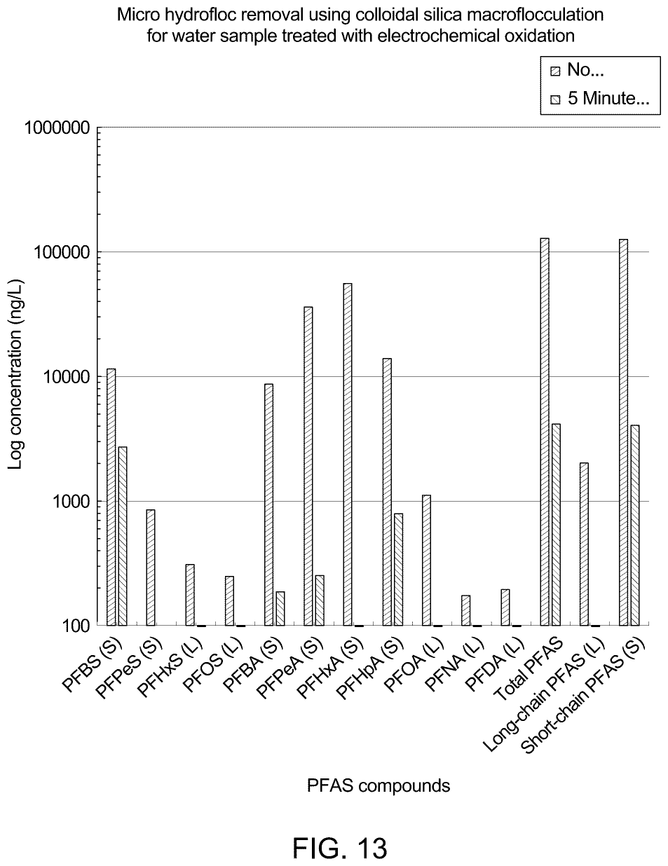

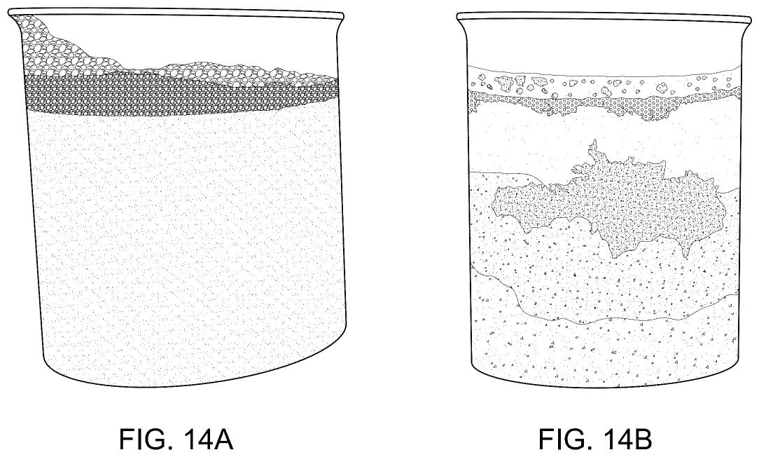

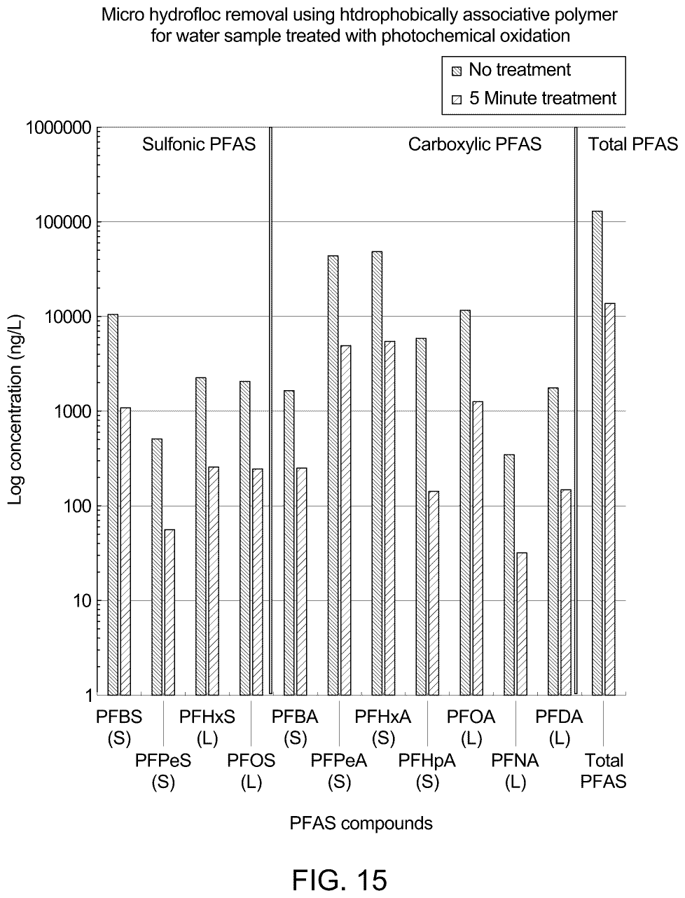

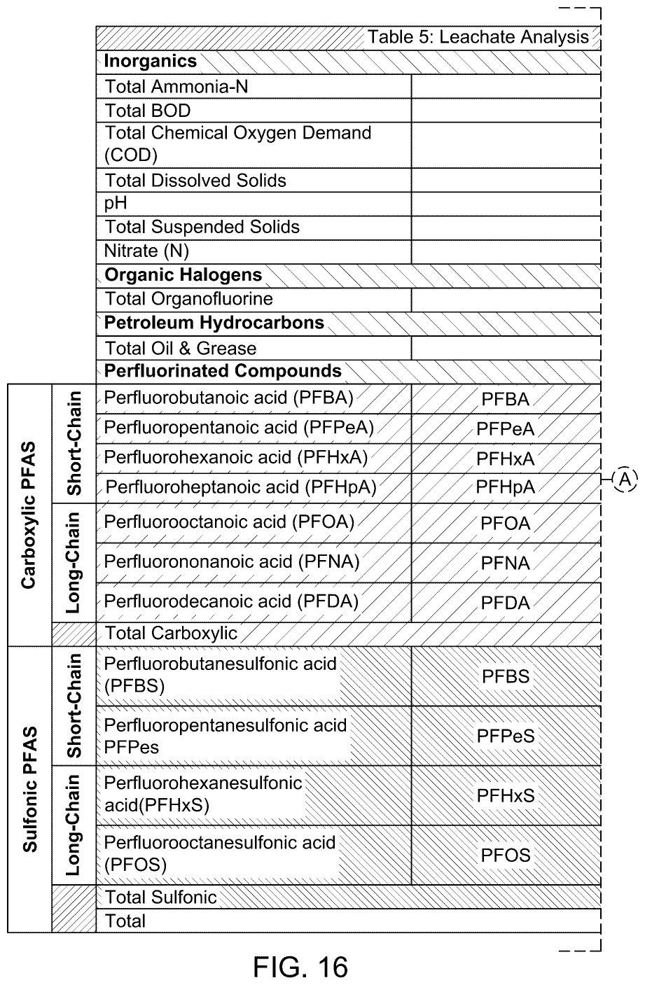

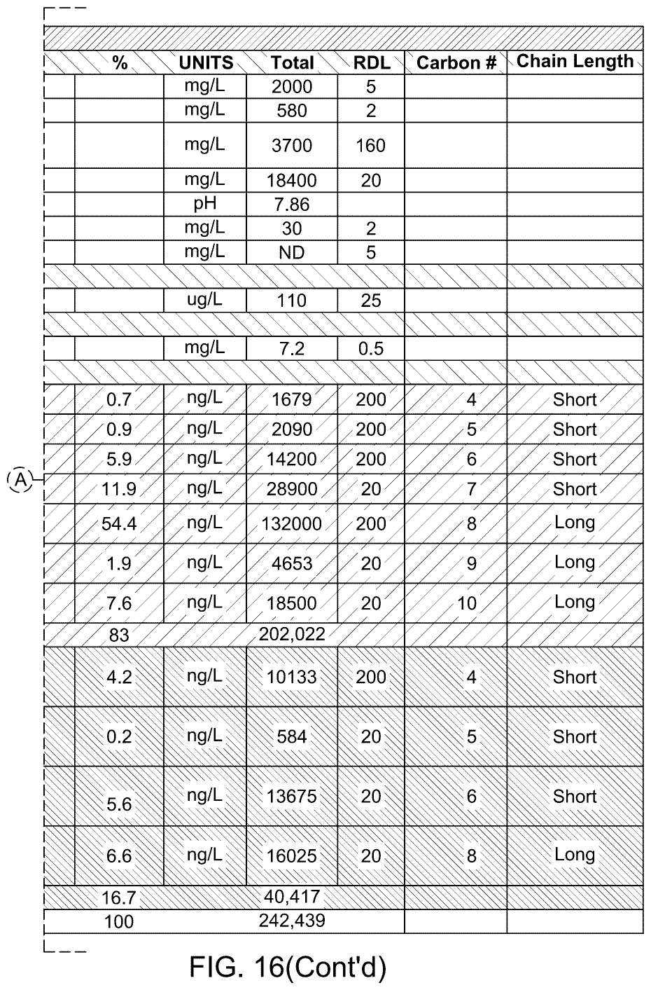

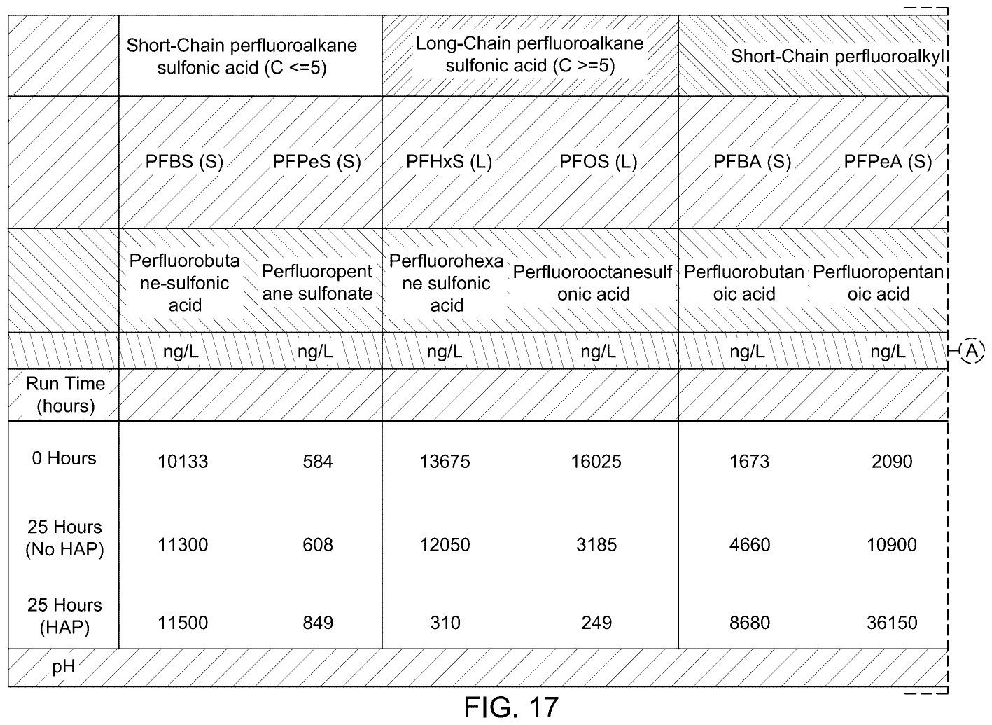

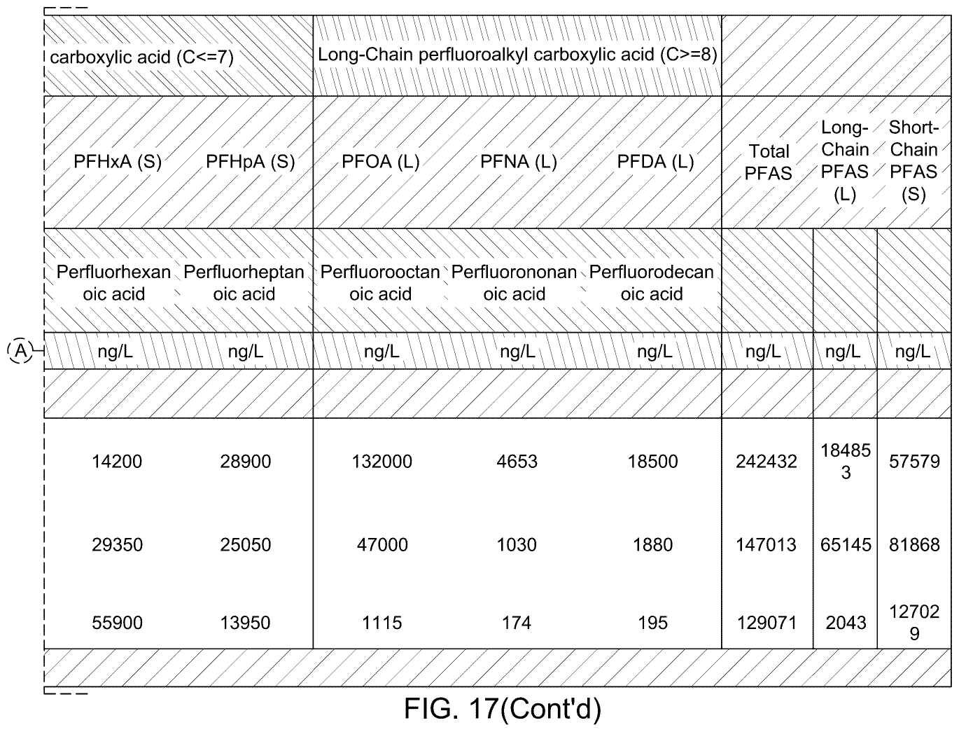

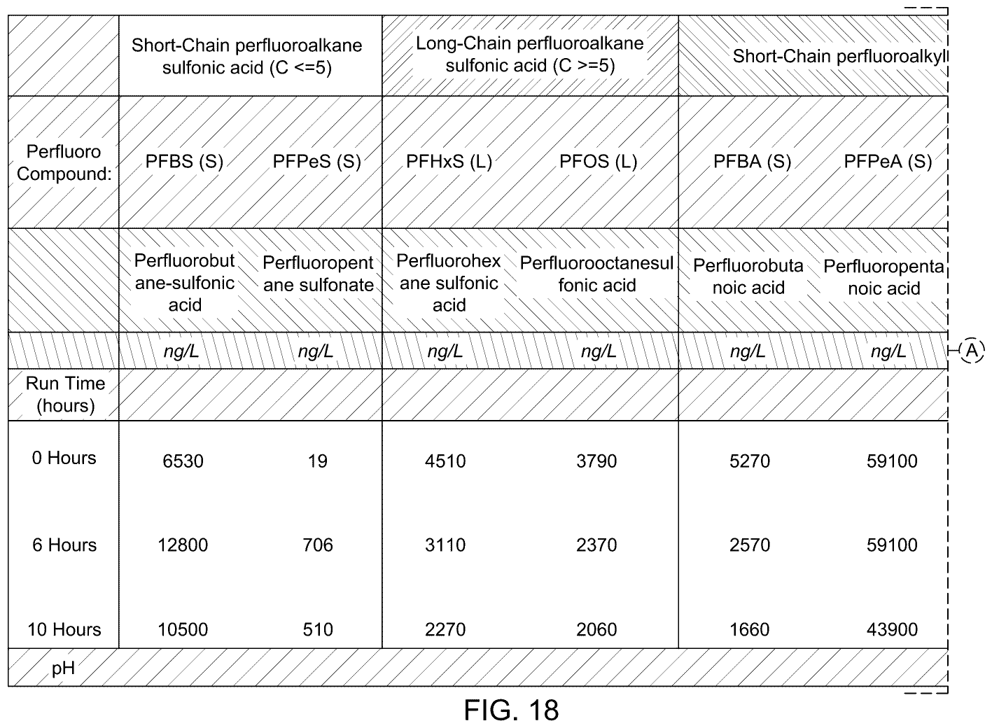

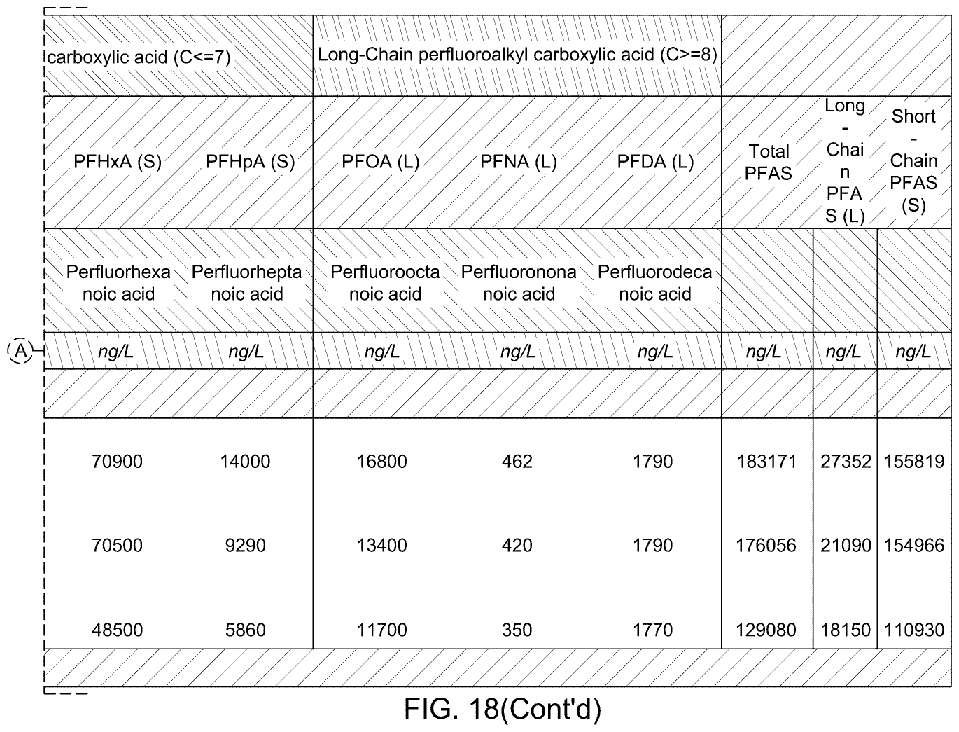

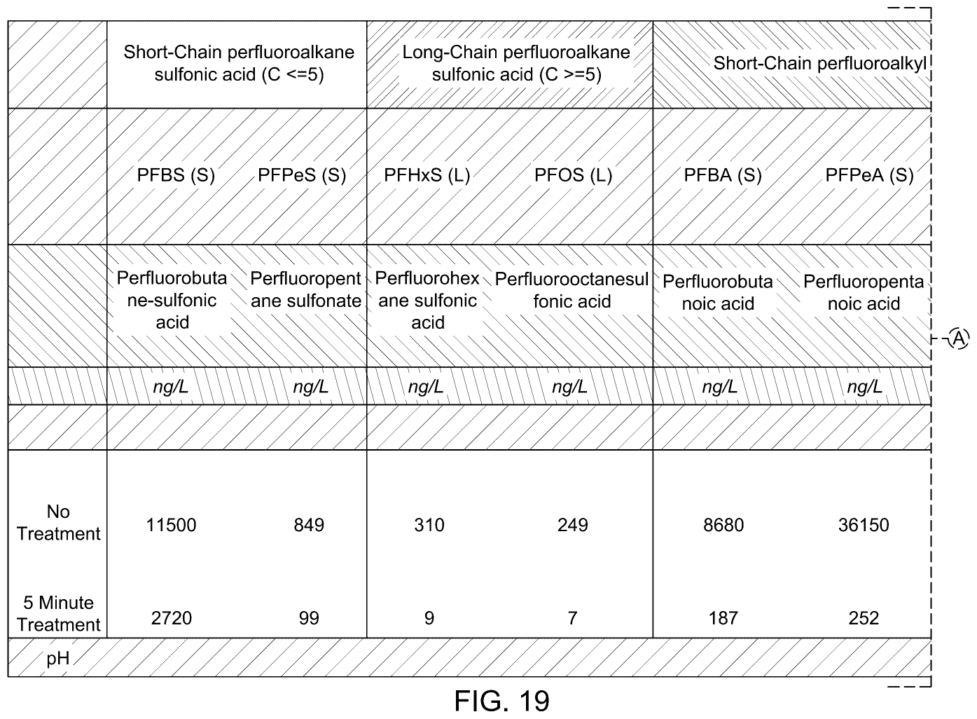

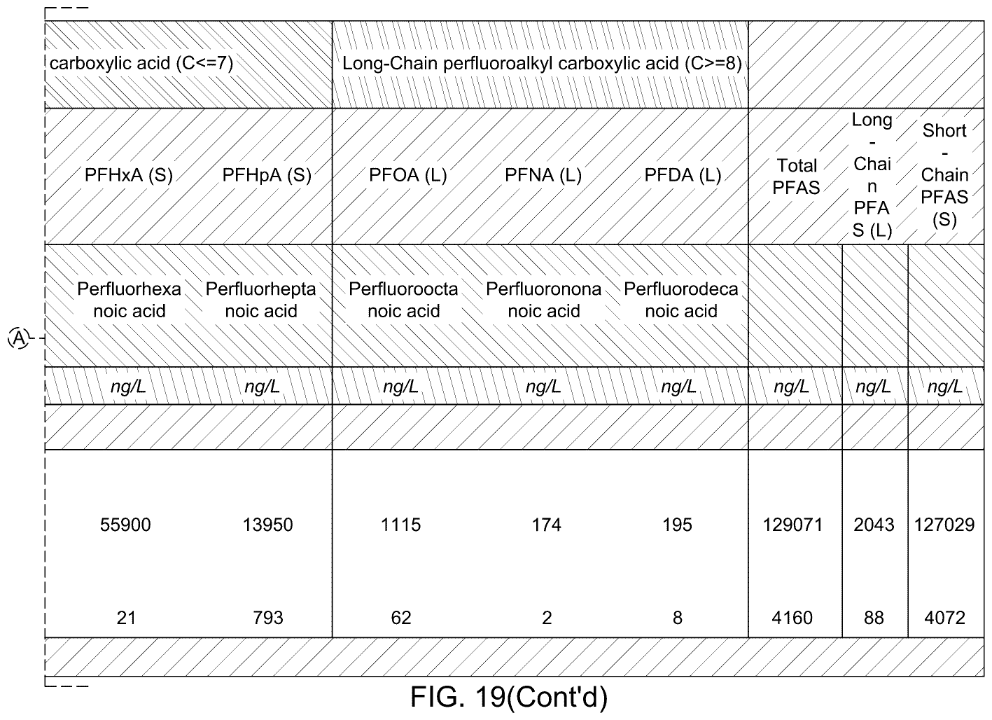

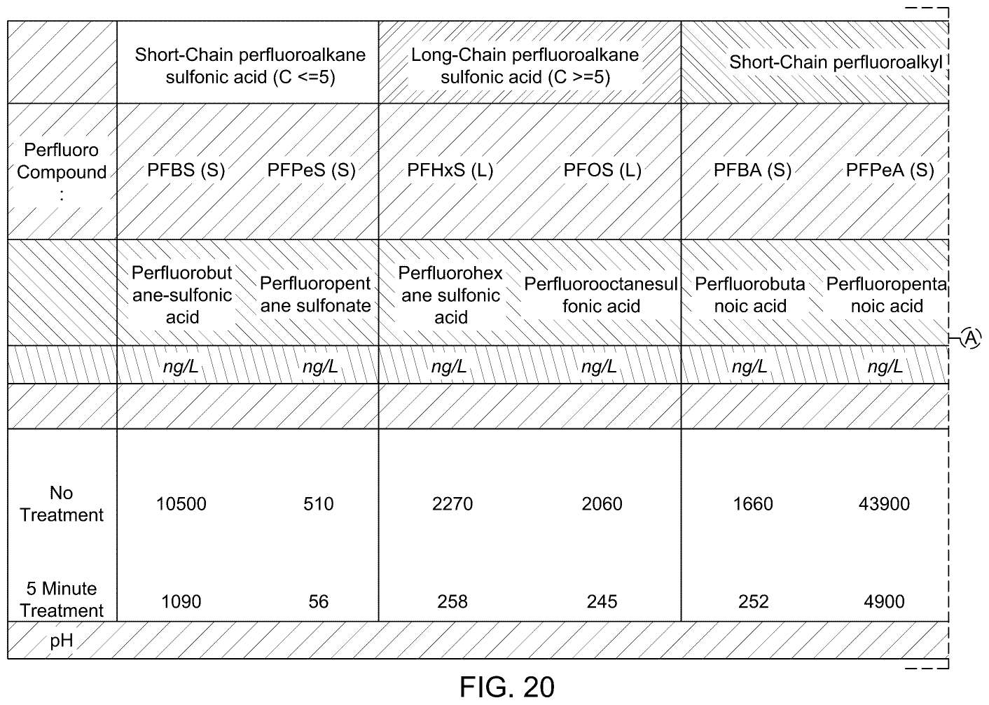

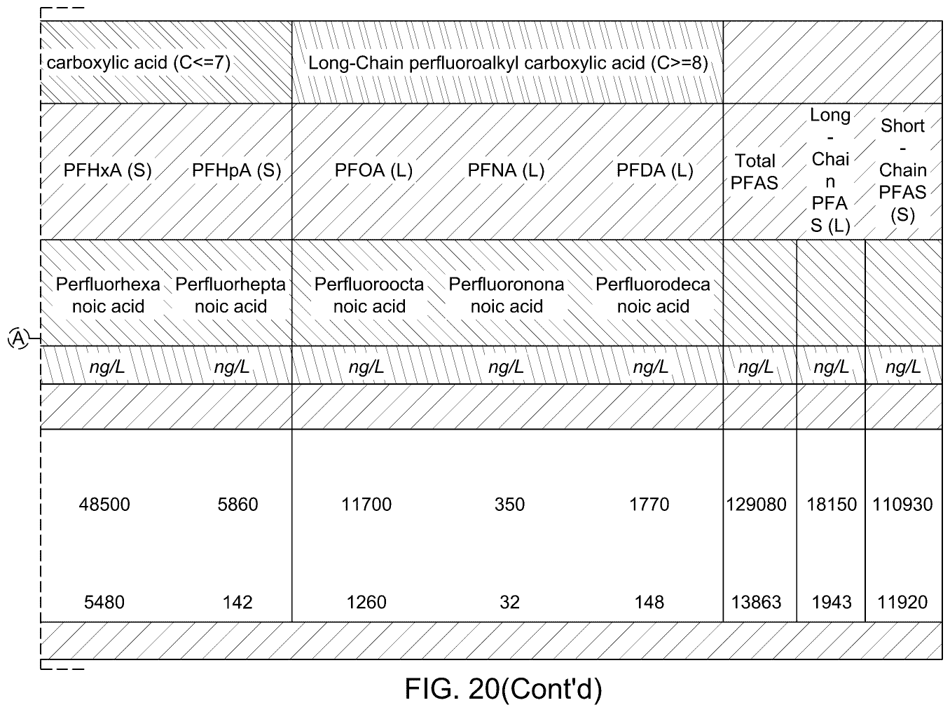

FIGS. 14a and 14b are pictures of Micro Hydroflocs before (14a) and after (14b) treatment with Colloidal Silica or Hydrophobically Associative Polymer.

FIG. 15 shows the composition of the PFAS compounds in leachate after electrochemical coagulation and treatment with hydrophobically associative polymer. After 5 minutes, the removal rate of the PFAS molecules, long and short, was >90%.

Table 2 shows the composition of the PFAS compounds in leachate is shown electrochemical coagulation and treatment with hydrophobically associative polymer. After 5 minutes, the removal rate of the PFAS molecules, long and short, was >90%.

### Example 1

### Treating a PFAS Leachate Solution Using an Electrochemical Oxidation Method

Ten (10) gallons of PFAS leachate having the composition described in Table 1 and FIG. 9 having a total PFAS concentration of 242,000 ppm was measured and placed into a 20-gallon recirculation vessel. The recirculation vessel was connected to a recirculation pump with a recirculation flow of 2 l/min. The recirculation leachate flowed through an electrochemical oxidation cell containing a Magneli titanium oxide anode and an inert titanium cathode. The PFAS solution was electrolyzed at room temperature using a DC power supply, with a constant current density of 50 mA/cm², a voltage of 5 volts and a spacing between the electrode plates of about 2 mm. pH was initially 7 with no further correction. Reaction temperature was maintained between 20 and 30 Celsius. The leachate was amended with 10 mmole/litre of Na₂SO₄. Sampling and analysis were done on an hourly basis. The schematic set-up of the system is shown in FIG. 10A.

As shown in FIG. 11 (Table 2), after 25 hours of the electrolysis reaction, the removal rate of the long chain PFAS molecules was >99%. The overall removal of PFAS (long and short chain) was 47%. However, we see an increase of short chain PFAS molecules from 57,000 ppm to 127,000 ppm. The increase is due to the degradation of the long chain PFAS molecules to short chain molecules.

### Example 2

### Treating a PFAS Solution Using a Photochemical AOP Oxidation Method

Ten gallons of PFAS leachate having the composition described in Table 1 and FIG. 9 having a total PFAS concentration of 242,000 ppm was measured and placed into a 20-gallon recirculation vessel. The recirculation tank was connected to a recirculation pump which flowed into a 0.5 kW photochemical AOP Oxidation cell with a recirculation flow of 2 l/min. No cooling was necessary. Initial leachate temperature was 20 Celsius. The leachate was amended with 5 mmole/litre of Na₂SO₃, and pH was adjusted to 9.5-10.0 with NaOH and kept within the range during the reaction. Sampling and analysis were done on an hourly basis. The schematic set-up of the system is shown in FIG. 10B.

As shown in FIG. 12 and FIG. 18, after 10 hours of the photochemical oxidation, the removal rate of the long chain PFAS molecules was >66%. The overall removal of PFAS (long and short chain) was >70%. Unlike electrochemical oxidation, photochemical oxidation was very effective at removing PFAS. Large chain PFAS molecules were not degraded to the same extent to short chain PFAS as in the electrochemical oxidation process. Although the reaction was ceased at 10 hours for sample collection, repeat testing of the reaction showed a 100% removal of PFAS after 15 hours.

### Example 3

### Treating a PFAS Solution from Example 1 Using an Electrochemical Coagulation Method

Ten gallons of PFAS leachate treated as per Example 1 having a total PFAS concentration of 127,000 ppm PFAS concentration was treated with an electrochemical coagulation cell. The 20-litre recirculation vessel was connected to a recirculation pump with a recirculation flow of 2 l/min. The recirculation leachate flowed through an electrochemical coagulation cell containing a solid aluminum anode and an inert titanium cathode. The schematic set-up of the system is shown in FIG. 10C.

The PFAS solution was electrolyzed at room temperature using a DC power supply, with a constant current density of 20 mA/cm², a voltage of 10 volts and a spacing between electrode plates of about 12 mm. Starting pH was 8.5. Temperature was 25 Celsius. The leachate was not amended with any electrolyte. The reaction was carried out for 30 minutes. At the end of 30 minutes the power was shut off, but the recirculation pump was allowed to continue pumping. Final pH was measured to be 10.4. The micro hydroflocs formed are shown in FIG. 14A.

### Example 4

### Treating a PFAS Solution from Example 2 sing an Electrochemical Coagulation Method

Ten gallons of PFAS leachate treated as per Example 2 having a total PFAS concentration of 129,000 ppm PFAS concentration was treated with an electrochemical coagulation cell. The 20-litre recirculation vessel was connected to a recirculation pump with a recirculation flow of 2 l/min. The recirculation leachate flowed through an electrochemical coagulation cell containing a solid aluminum anode and an inert titanium cathode. The schematic set-up of the system is shown in FIG. 10C.

The PFAS solution was electrolyzed at room temperature using a DC power supply, with a constant current density of 20 mA/cm², a voltage of 10 volts and a spacing between electrode plates of about 12 mm. Starting pH was 8.5. Temperature was 25 Celsius. The leachate was not amended with any electrolyte. The reaction was carried out for 30 minutes. At the end of 30 minutes the power was shut off, but the recirculation pump was allowed to continue pumping. Final pH was measured to be 10.4. The micro hydroflocs formed are shown in FIG. 14A. As in Example 3, similar micro hydroflocs are formed.

### Example 5

### Treating a Micro-Hydroflocs formed from Example 3 Using Colloidal Microparticulate Flocculation

Ten litres of treated leachate from example 3 was carefully transferred to a 12-litre protein skimmer. 100 ppm, based on SiO₂,of colloidal silica was added to the treated leachate micro hydrofloc solution. The colloidal silica used was 13.5% SiO₂ with a mean particle diameter of 4nm. The colloidal silica pH was 11.1.

Dispersed air generated by the protein skimmer was then injected into the protein skimmer vessel. The hydraulic recirculation flow was 10 l/min. The air injection (protein skimmer air draw) was adjusted to form small floatable, macro hydroflocs which quickly aggregate to form large fluffy flocs as shown in FIG. 14b. Typical air flow was 5.7 l/min. The sludge was collected at the top of the protein skimmer by overflow. The system was run for 5 minutes.

As shown in FIG. 13 and FIG. 19, after 5 minutes, the removal rate of the PFAS molecules, long and short, was >97%.

### p Example 6

### Treating Micro-Hydroflocs formed from Example 4 Using Hydrophobically Associative Polymer (HAP) Flocculation

Ten litres of treated leachate from example 4 was carefully transferred to a 12-litre protein skimmer. 200 ppm of HAP was added to the treated leachate micro hydrofloc solution as a 20% solution. The HAP was 25% solids, −30% anionic, cross-linked dispersion polymer.

Dispersed air generated by the protein skimmer was then injected into the protein skimmer vessel. The hydraulic recirculation flow was 10 l/min. The air injection (protein skimmer air draw) was adjusted to form small floatable, macro hydroflocs which quickly aggregate to form large fluffy flocs as shown in FIG. 14b. Typical air flow was 3.9 l/min. The sludge was collected at the top of the protein skimmer by overflow. The system was run for 5 minutes.

As shown in FIG. 15 and FIG. 20, after 5 minutes, the removal rate of the PFAS molecules, long and short, was >90%.

1. A method for removing at least one PFAS compound, selected from perfluoroalkyl acids (or their salts) having a number of carbon atoms ranging from 4 to 20, from a liquid medium, the method comprising:
a. Treating the medium with one or more gelling aids whereby the contaminants become more electroactive and form a microgel;
b. Oxidizing the electroactive microgel whereby the carbon chain length of the contaminants is reduced;
c. Forming micro-hydroflocs through electrochemical coagulation whereby the contaminants are adsorbed and/or absorbed into micro-hydroflocs.
d. Aerating the medium thereby separating the micro-hydroflocs from the medium and producing macroflocs;
e. Separating the macroflocs from the liquid medium by flotation.

2. The method according to claim 1, wherein the one or more gelling aids comprise hydrophobic associative polymers comprising salt-resistant hydrophobic side chains.

3. The method according to claim 2, wherein the polymers comprise 0.0001 to 10 wt.-% of at least one hydrophobic group.

4. The method according to claim 1, wherein the oxidation is electrochemical oxidation.

5. The method according to claim 1, wherein the oxidation comprises either simultaneous or sequential electrochemical oxidation and an advanced oxidation process.

6. The method according to claim 1, wherein the oxidation comprises either simultaneous or sequential electrochemical oxidation and ultraviolet (UV) treatment.

7. The method according to claim 5, wherein the oxidation occurs in an advanced oxidation process reactor comprising a UV/H₂O₂, O₃, H₂O₂/Fe²⁺ or O₃/H₂O₂ or UV-persulfate treatment.

8. The method according to claim 4, wherein an oxidation process system oxidizes the electroactive microgel, the system comprising at least one UV lamp.

9. The method according to claim 5, wherein the advanced oxidation process comprises a chemical feed system which adds H₂O₂, O₃, Fe²⁺, O₃/H₂O₂ and/or persulfate to the contaminated water media.

10. The method according to claim 6 wherein Ti₄O₇ acts as catalyst for the UV treatment.

11. The method according to claim 1, wherein an electrochemical oxidation system oxidizes the electroactive microgel, the system comprising at least one electrochemical cell.

12. The method according to claim 11, wherein the electrochemical cell comprises a Magneli phase titanium oxide anode.

13. The method according to claim 11, wherein the electrochemical cell has an anode comprising a Tiₙ, O₂ₙ₋₁ (n=4-10) electrode.

14. The method according to claim 13, wherein the anode comprises Ti₄O₇.

15. The method according to claim 12, wherein the anode comprises a mixture of Magneli-phase titanium oxides.

16. The method according to claim 11, wherein the electrochemical cell has a cathode comprising stainless steel, a nickel alloy, or titanium and/or combinations thereof.

17. The method according to claim 1, wherein the electrical coagulation uses at least one anode of electrodes.

18. The method according to claim 17, wherein the anode of electrodes comprises aluminum, iron, zinc, copper, or magnesium, or alloys of aluminum, iron, zinc, copper, and/or magnesium.

19. The method according to claim 1, the method comprising adding one or more micro-flocculating agents to the water medium after the oxidation step.

20. The method according to claim 19, wherein the micro-flocculating agents comprise crosslinked micropolymers.

21. The method according to claim 19, wherein the micro-flocculating agents comprise colloidal silica with particle diameters less than 400 nm.

22. The method according to claim 1, wherein the macroflocs form a sludge.

23. The method according to claim 1, wherein the liquid medium is subjected to air or convection flotation forming a treated liquid substantially free of contaminants and a sludge formed from the micro hydroflocs.

24. The method according to claim 22, wherein the sludge is drained and compressed to form a higher solid content sludge and a filtrate.

25. The method according to claim 1, wherein the contaminants comprise perfluorooctanoic acid (PFOA), perfluorooctane sulfonic acid (PFOS), perfluorononanoic acid (PFNA), perfluorodecanoic acid (PFDA), perfluorooctane sulfonyl fluoride (POSF), fluorotelomer alcohol (8:2 FTOH), N-ethyl perfluorooctane sulfonyl fluoride, N-ethyl perfluorooctane sulfonamido acetic acid, or 1H, 1H, 2H, 2H-perfluorooctane sulfonic acid, or combinations thereof.
